(19) United States
(12) Patent Application Publication
(10) Pub. No.: US 2026/0052487 A1
(43) Pub. Date: Feb. 19, 2026

(54) WIRELESS COMMUNICATION METHOD AND TERMINAL DEVICE

(71) Applicant: GUANGDONG OPPO MOBILE TELECOMMUNICATIONS CORP., LTD., Dongguan (CN)

(72) Inventor: Zuomin WU, Dongguan (CN)

(21) Appl. No.: 19/369,718

(22) Filed: Oct. 27, 2025

Related U.S. Application Data
(63) Continuation of application No. PCT/CN2023/104184, filed on Jun. 29, 2023.

(51) Int. Cl. H04W 56/00; H04L 5/00

(52) U.S. Cl. CPC H04W 56/0005; H04L 5/0048

(57) ABSTRACT

A wireless communication method and a terminal device are provided. The wireless communication method includes the following. A terminal device detects a synchronization signal sent by a network device. The terminal device determines at least one antenna port associated with a first synchronization signal according to the first synchronization signal, after the terminal device detects the first synchronization signal.

### CROSS-REFERENCE TO RELATED APPLICATION (S)

This application is a continuation of International Application No. PCT/CN2023/104184, filed Jun. 29, 2023, the disclosure of which is hereby incorporated by reference in its entirety.

### TECHNICAL FIELD

This disclosure relates to the field of communication technology, in particular to a wireless communication method and a terminal device.

### BACKGROUND

With the advancement of communication technology, communication systems are placing higher demands on wireless network coverage. In this regard, distributed antenna systems are introduced into some communication systems, to quickly and flexibly build wireless networks that meet user needs. However, how terminal devices and network devices establish communication connections in the scenario of the distributed antenna system is currently unclear.

### SUMMARY

The present application provides a wireless communication method and a terminal device. The following introduces various aspects of the present application.

In a first aspect, a wireless communication method is provided. The method includes the following. A terminal device detects a synchronization signal sent by a network device. The terminal device determines at least one antenna port associated with a first synchronization signal according to the first synchronization signal, after the terminal device detects the first synchronization signal.

In a second aspect, a wireless communication method is provided. The method includes the following. A network device sends a synchronization signal, where the synchronization signal includes a first synchronization signal, and the first synchronization signal is used to determine at least one antenna port associated with the first synchronization signal.

In a third aspect, a terminal device is provided. The terminal device includes a transceiver, at least one processor, and a memory. The memory is coupled to the at least one processor and stores at least one computer program. When executed by the at least one processor, the at least one computer program causes the at least one processor to execute part or all of the steps in the method of the first aspect.

### BRIEF DESCRIPTION OF THE DRAWINGS

FIGS. 1A to 1C are schematic diagrams of architectures of wireless communication systems applicable to embodiments of the present application.

FIGS. 2A to 2C are schematic diagrams of architectures of wireless communication systems applicable to embodiments of the present application.

FIG. 3 is a schematic diagram of a mapping relationship between SSBs and ROs.

FIG. 4 is a schematic flow chart of a 4-step random access procedure.

FIG. 5 is a schematic flow chart of a 2-step random access procedure.

FIG. 6 is a schematic flow chart of a wireless communication method provided in an embodiment of the present application.

FIG. 7 is a schematic flow chart of a wireless communication method provided in another embodiment of the present application.

FIG. 8 is a schematic flow chart of a wireless communication method provided in yet another embodiment of the present application.

FIG. 9 is a schematic diagram of a network structure based on a distributed antenna system provided in an embodiment of the present application.

FIG. 10 is a schematic diagram of a network structure based on a distributed antenna system provided in another embodiment of the present application.

FIG. 11 is a schematic diagram of synchronization signal transmission provided in an embodiment of the present application.

FIG. 12 is a schematic diagram of synchronization signal transmission provided in another embodiment of the present application.

FIG. 13 is a schematic structural diagram of a terminal device provided in embodiments of the present application.

FIG. 14 is a schematic structural diagram of a network device provided in embodiments of the present application.

FIG. 15 is a schematic structural diagram of a communication apparatus provided in embodiments of the present application.

### DETAILED DESCRIPTION

### Architecture of Communication System

Technical solutions of embodiments of the present application are applicable to various communication systems, for example, a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolved system of the NR system, an LTE-based access to unlicensed spectrum (LTE-U) system, an NR-based access to unlicensed spectrum (NR-U) system, a non-terrestrial network (NTN) system, universal mobile telecommunication system (UMTS), a wireless local area network (WLAN), wireless fidelity (WLAN), wireless fidelity (WiFi), fifth-generation communication (5G) systems or other communication systems, such as future communication systems, such as sixth-generation (6G) systems, and satellite communication systems.

Generally speaking, a conventional communication system generally supports a limited number (or quantity) of connections and therefore is easy to implement. However, with development of communication technology, a mobile communication system will not only support conventional communication but also support, for example, device to device (D2D) communication, machine to machine (M2M) communication, machine type communication (MTC), vehicle to vehicle (V2V) communication, or vehicle to everything (V2X) communication, etc. Embodiments of the disclosure can also be applied to these communication systems.

The communication system in embodiments of the disclosure may be applied to a carrier aggregation (CA) scenario, or may be applied to a dual connectivity (DC) scenario, or may be applied to a standalone (SA) network deployment scenario.

The communication system in the embodiment of the present application can be applied to an unlicensed spectrum, where the unlicensed spectrum can also be considered as a shared spectrum. Alternatively, the communication system in the embodiment of the present application can also be applied to a licensed spectrum, where the licensed spectrum can also be considered as a dedicated spectrum.

The embodiments of the present application can be applied to NTN systems as well as terrestrial network (TN) systems. By way of explanation rather than limitation, the NTN system includes an NR-based NTN system and an IoT-based NTN system.

Various embodiments of the present application are described in conjunction with the network device and the terminal device, where the terminal device may also be referred to as a user equipment (UE), an access terminal, a user unit, a user station, a mobile radio station, a mobile station (MS), a mobile terminal (MT), a remote station, a remote terminal, a mobile device, a user terminal, a terminal, a wireless communication device, a user agent, or a user device, etc.

In an embodiment of the present application, the terminal device may be a station (ST) in a WLAN, a cellular radio telephone, a cordless telephone, a session initiation protocol (SIP) telephone, a wireless local loop (WLL) station, a personal digital assistant (PDA), a handheld device or a computing device with wireless communication functions, other processing devices coupled with a wireless modem, an in-vehicle device, a wearable device, and a terminal device in a next-generation communication system, for example, a terminal device in an NR network, or a terminal device in a future evolved public land mobile network (PLMN), etc.

In embodiments of the present application, the terminal device may be a device that provides voice and/or data connectivity to a user and can be used to connect people, objects, and machines, such as a handheld device or in-vehicle device with a wireless connectivity function. The terminal device in embodiments of the present application may be a mobile phone, a tablet, a laptop, a PDA, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, etc. Optionally, a UE may be used to act as a base station. For example, the UE may act as a scheduling entity, providing sidelink signals between UEs in V2X or D2D, etc. For example, a cell phone and a car communicate with each other using sidelink signals. The cellular phone and the smart home device communicate with each other without relaying the communication signal through the base station.

In embodiments of the disclosure, the terminal device may be deployed on land, such as indoor or outdoor, handheld, wearable, or in-vehicle. The terminal device may also be deployed on water (such as ships, etc.). The terminal device may also be deployed in the air (such as airplanes, balloons, satellites, etc.).

By way of explanation rather than limitation, in embodiments of the disclosure, the terminal device may also be a wearable device. The wearable device may also be called a wearable smart device, which is a generic term of wearable devices obtained through intelligent design and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone.

The network device in the embodiments of the present application may be a device for communicating with the terminal device. The network device may also be referred to as an access network device or a radio access network device. For example, the network device may be a base station. The network device in the embodiments of the present application may refer to a radio access network (RAN) node (or device) that connects the terminal device to a wireless network. The base station may broadly cover the following various names, or be interchangeable with the following names, such as: NodeB, evolved NodeB (eNB), next generation NodeB (gNB), relay station, access point, transmitting and receiving point (TRP), transmitting point (TP), master eNB (MeNB), secondary eNB (SeNB), multi-standard radio (MSR) node, home base station, network controller, access node, wireless node, access point (AP), transmission node, transceiver node, baseband unit (BBU), remote radio unit (RRU), active antenna unit (AAU), remote radio head (RRH), central unit (CU), distributed unit (DU), positioning node, etc. The base station may be a macro base station, a micro base station, a relay node, a donor node, or the like, or a combination thereof. The base station may also refer to a communication module, modem, or chip used to be installed in the aforementioned devices or apparatuses. The base station may also be a mobile switching center, a device that functions as the base station in device-to-device (D2D), vehicle-to-everything (V2X), and machine-to-machine (M2M) communication, a network-side device in a 6G network, or a device that functions as the base station in future communication systems. The base station may support networks with the same or different access technologies. The specific technologies and device forms used by network device are not limited in the embodiments of the present application.

The base station can be fixed or mobile. For example, a helicopter or drone can be configured to act as a mobile base station, and one or more cells can move according to the location of the mobile base station. In other examples, a helicopter or drone can be configured to act as a device that communicates with another base station.

In some deployments, the network device in the embodiments of the present application may refer to a CU or a DU, or the network device may include a CU and a DU. The gNB may also include an AAU.

The network device and the terminal device can be deployed on land such as indoors or outdoors, handheld or vehicle-mounted. The network device and the terminal device can also be deployed on water. The network device and the terminal device can also be deployed in the air on aircraft, balloons, and satellites. The scenarios to which the network device and the terminal device are applied are not limited in the embodiments of the present application.

By way of explanation rather than limitation, in embodiments of the disclosure, the network device may be mobile. For example, the network device may be a mobile device. In some embodiments of the present application, the network device may be a satellite or a balloon base station. For example, the satellite may be a low earth orbit (LEO) satellite, a medium earth orbit (EO) satellite, a geostationary earth orbit (GEO) satellite, a high elliptical orbit (HEO) satellite, etc. In some embodiments of the present application, the network device may also be a base station deployed on land or water.

In embodiments of the disclosure, the network device serves a cell, and the terminal device communicates with the network device on a transmission resource (for example, a frequency-domain resource or a spectrum resource) for the cell. The cell may be a cell corresponding to the network device (for example, a base station). The cell may belong to a macro base station, or may belong to a base station corresponding to a small cell. The small cell may include: a metro cell, a micro cell, a pico cell, a femto cell, and the like. These small cells are characterized by small coverage and low transmission power and are adapted to provide data transmission service with high-rate.

In some embodiments, communication system scenarios may include TN and NTN. NTN typically uses satellite communication to provide communication services to terrestrial users. Currently, NTN systems include NR-NTN and IoT-NTN systems, and may include other NTN systems in the future. For ease of understanding, the following describes communication scenarios for TN and NTN, respectively, with reference to the accompanying figures.

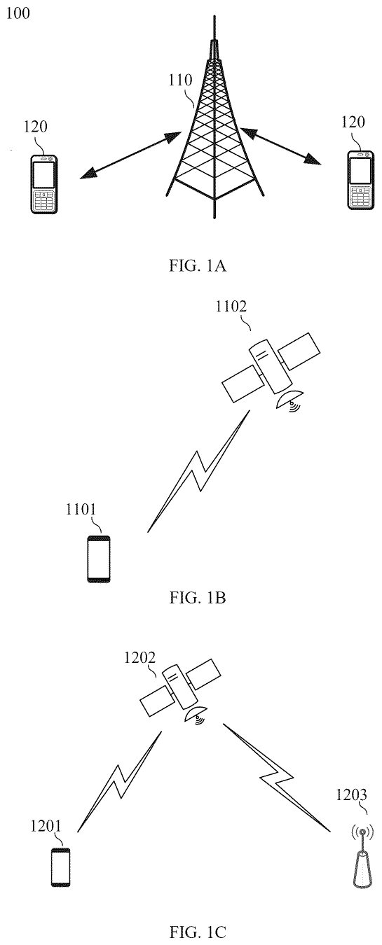

For example, FIG. 1A is a schematic diagram of an architecture of a communication system provided in embodiments of the present application. As illustrated in FIG. 1A, the communication system 100 may include a network device 110. The network device 110 may be a device that communicates with a terminal device 120 (also referred to as a communication terminal device or terminal). The network device 110 may provide communication coverage for a specific geographic area and may communicate with terminal devices within the coverage area.

FIG. 1A exemplarily illustrates one network device and two terminal devices. In some embodiments of the present application, the communication system 100 may include multiple network devices and there may be other numbers of terminal devices in the coverage of each network device, which is not limited in the embodiments of the present application.

Exemplarily, FIG. 1B is another schematic diagram of an architecture of a communication system provided in embodiments of the present application. Referring to FIG. 1B, a terminal device 1101 and a satellite 1102 are included, and wireless communication can be performed between the terminal device 1101 and the satellite 1102. The network formed between the terminal device 1101 and the satellite 1102 can also be referred to as an NTN. In the architecture of the communication system illustrated in FIG. 1B, the satellite 1102 can function as a base station, and the terminal device 1101 and the satellite 1102 can communicate directly. In the system architecture, the satellite 1102 can be referred to as a network device. In some embodiments of the present application, multiple network devices 1102 may be included in the communication system, and there may be other numbers of terminal devices in the coverage of each network device 1102, which is not limited in the embodiments of the present application.

Exemplarily, FIG. 1C is another schematic diagram of an architecture of a communication system provided in embodiments of the present application. Referring to FIG. 1C, a terminal device 1201, a satellite 1202, and a base station 1203 are included. Wireless communication can be performed between the terminal device 1201 and the satellite 1202, and communication can be performed between the satellite 1202 and the base station 1203. The network formed between the terminal device 1201, the satellite 1202, and the base station 1203 can also be referred to as an NTN. In the architecture of the communication system illustrated in FIG. 1C, the satellite 1202 may not function as a base station, and the communication between the terminal device 1201 and the base station 1203 needs to be relayed via the satellite 1202. In the system architecture, the base station 1203 can be referred to as a network device. In some embodiments of the present application, multiple network devices 1203 may be included in the communication system, and there may be other numbers of terminal devices in the coverage of each network device 1203, which is not limited in the embodiments of the present application.

It should be noted that FIGS. 1A to 1C are only examples of systems applicable to the present application. The method illustrated in the embodiments of the present application can also be applied to other systems, such as 5G communication systems, LTE communication systems, etc., which is not limited in the embodiments of the present application.

In some embodiments of the present application, the wireless communication system illustrated in FIGS. 1A-1C may also include other network entities such as a mobility management entity (MME) and an access and mobility management function (AMF), but the embodiments of the present application are not limited to this.

It should be understood that in the embodiments of the present application, a device having a communication function in a network/system may be referred to as a communication device. Taking the communication system 100 illustrated in FIG. 1A as an example, the communication device may include the network device 110 and the terminal device 120 having the communication functions. The network device 110 and the terminal device 120 may be the specific devices described above and will not be described in detail here. The communication device may also include other devices in the communication system 100, such as a network controller, a mobility management entity, and other network entities, which are not limited in the embodiments of the present application.

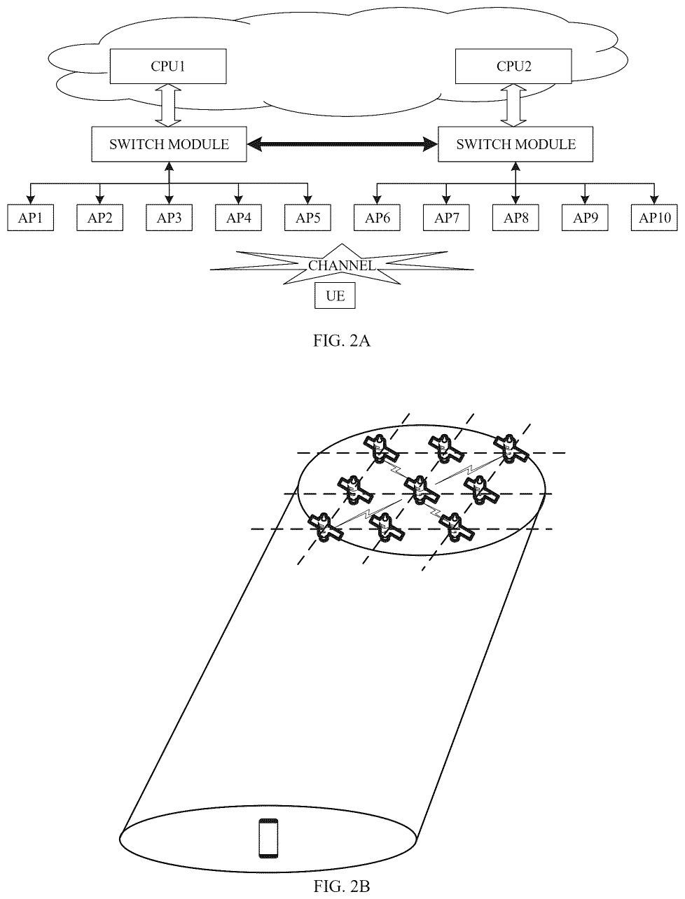

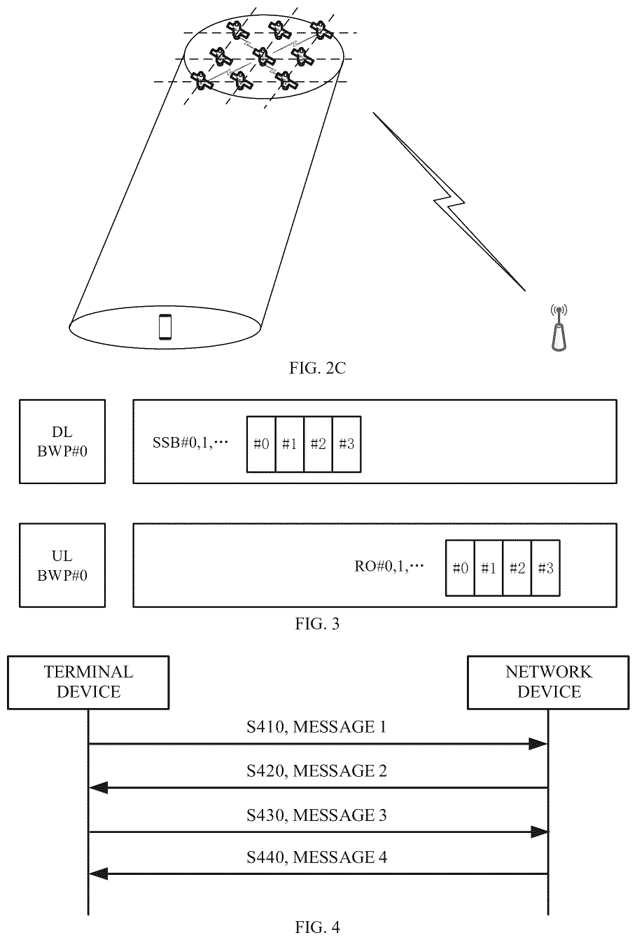

With the development of communication technology, the communication system architecture may also change. For example, in the future evolved communication systems, such as 5G (B5G), or 6G, distributed multiple-input multiple-output (distributed MIMO, also known as distributed antenna system) and/or massive multiple-input multiple-output (massive MIMO, also known as massive antenna matrix system) scenarios may be introduced. In some cases, distributed MIMO and/or massive MIMO may also support cell-free or UE-centric network deployments. It should be understood that the scenarios are applicable to both TN and/or NTN. The following provides an exemplary introduction to the communication system architectures with reference to FIGS. 2A-2C.

Exemplarily, FIG. 2A is a schematic diagram of an architecture of a communication system provided in embodiments of the present application. The system architecture may include one or more of: a distributed antenna port (distributed AP or distributed AP cluster), a central processing unit (CPU), or a switch module. As illustrated in FIG. 2A, the communication system may include multiple distributed antenna ports (or distributed antenna port clusters), and different distributed antenna ports (or distributed antenna port clusters) are connected to the CPU through the switch module. The terminal device selects an appropriate distributed antenna port (or distributed antenna port cluster) to serve the terminal device according to the location area of the terminal device. FIG. 2A exemplarily illustrates two CPUs, two switch modules, ten distributed antenna ports and one terminal device. In some embodiments of the present application, the communication system may include other numbers of CPUs, and/or other numbers of switch modules, and/or other numbers of distributed antenna ports (or distributed antenna port clusters), and/or other numbers of terminal devices, and the embodiments of the present application are not limited to this.

Exemplarily, FIG. 2B is another schematic diagram of an architecture of a communication system provided in embodiments of the present application. Referring to FIG. 2B, a terminal device and a satellite cluster are included, and wireless communication can be performed between the terminal device and the satellite cluster. The network formed between the terminal device and the satellite cluster can also be referred to as an NTN. In the architecture of the communication system illustrated in FIG. 2B, at least one satellite in the satellite cluster (for example, a satellite located in a central location) can function as a base station, and the terminal device and the satellite cluster can communicate directly. In the system architecture, a satellite that functions as the base station can be referred to as a network device. In some embodiments of the present application, a communication system may include multiple satellite clusters. In some embodiments, each satellite cluster may include one or more network devices. In some embodiments, there may be other numbers of terminal devices within the coverage of each satellite cluster or each network device, and the embodiment of the present application does not limit this.

Exemplarily, FIG. 2C is another schematic diagram of an architecture of a communication system provided in embodiments of the present application. Reference is to FIG. 2C, a terminal device, a satellite cluster, and a base station are included. Wireless communication can be carried out between the terminal device and the satellite cluster, and communication can be carried out between the satellite cluster and the base station. The network formed between the terminal device, the satellite cluster, and the base station can also be referred to as NTN. In the architecture of the communication system illustrated in FIG. 2C, the satellite cluster may not function as a base station, and the communication between the terminal device and the base station needs to be relayed via the satellite cluster. In the system architecture, the base station can be referred to as a network device. In some embodiments of the present application, the communication system may include multiple satellite clusters. In some embodiments, one network device may be associated with one or more satellite clusters. In some embodiments, the communication system may include multiple network devices, and/or there may be other numbers of terminal devices within the coverage of each network device, which is not limited in the embodiments of the present application.

### Initial Access Procedure

To achieve uplink synchronization with the network device, the terminal device can perform an initial access procedure. Taking the initial access procedure in the NR system as an example, the initial access procedure is introduced below.

In the NR system, the initial access procedure of the terminal device can be achieved by detecting the synchronization signal/PBCH block (SSB or SS/PBCH block) on the synchronization raster.

In some embodiments, one SSB may include 4 symbols in a time domain.

In some embodiments, one SSB may include a primary synchronization signal (PSS), a secondary synchronization signal (SSS), and a physical broadcast channel (PBCH).

For example, the SSB can be transmitted within a discovery burst transmission window or SSB transmission window. The discovery burst transmission window or SSB transmission window occurs periodically, and the periodicity can be configured by the network device through higher-layer parameters. In some embodiments, one set of candidate positions for SSB transmission can be included in the discovery burst transmission window or SSB transmission window. One set of SSB transmission occasions (also known as one SSB burst set) can include one or more SSBs. One set of SSB transmission occasions should be within one half-frame (5 ms).

It should be understood that the physical-layer cell identities (ID) determined based on the SSBs transmitted in one set of SSB transmission occasions are all the same. This is because the physical-layer cell ID is determined based on a PSS sequence and an SSS sequence included in the SSB. For one SSB, the PSS sequence and the SSS sequence included are the same, so the physical-layer cell ID determined based on the same SSB is the same.

Specifically, the PSS included in one SSB includes 3 sequences and the terminal device determines

$${N}_{ID}^{( 2 )}$$

by detecting the PSS; the SSS includes 336 sequences and the terminal device determines

$${N}_{ID}^{( 1 )}$$

by detecting the SSS; the physical-layer cell ID is determined based on formula (1).

$${N}_{ID}^{cell} = 3 * {N}_{ID}^{( 1 )} + {N}_{ID}^{( 2 )} \qquad ( 1 )$$

For FR1, there can be up to eight SSBs in one set of SSB transmission occasions, requiring up to three bits to indicate indexes of the eight SSBs. As an implementation, the three bits can be implicitly carried in a demodulation reference signal (DMRS) sequence of the PBCH. There are eight different DMRS sequences of the PBCH, which correspond to eight different SSB indexes respectively.

For FR2, a maximum of 64 SSBs can be configured in one set of SSB transmission occasions, and 6 bits are required to indicate indexes of the 64 SSBs. As an implementation, lower 3 bits of the 6 bits can be carried by the DMRS sequence of the PBCH, and the additional upper 3 bits can be directly indicated by the PBCH payload.

Different SSBs can be indicated by different SSB indexes. One of the main functions of the SSB index is to allow the UE to obtain system timing information. In addition, the SSB index has another function, which is to indicate the quasi co-location (QCL) relationship between SSBs. QCL means that large-scale parameters of a channel over which a symbol on a certain antenna port is conveyed can be inferred from the channel over which a symbol on another antenna port is conveyed. The large-scale parameters may include delay spread, average delay, Doppler spread, Doppler shift, average gain, and spatial Rx parameters. In the NR system, considering the possible QCL relationship between various reference signals, the above-mentioned large-scale parameters of the channel can be divided into different QCL types, which is convenient for the system to configure according to different scenarios where the terminal device is located. For example, the QCL type in the NR system can include four different QCL types: QCL type A, QCL type B, QCL type C, and QCL type D. The definitions of different QCL type configurations are as follows:
‘QCL-Type A’: {Doppler shift, Doppler spread, average delay, delay spread};
‘QCL-Type B’: {Doppler shift, Doppler spread};
‘QCL-Type C’: {Doppler shift, average delay};
‘QCL-Type D’: {spatial Rx parameter}.

Specifically speaking of SSB, in the 5G NR system, SSBs carried by different beams constitute one SSB burst set. Different SSB indexes correspond to different SSB time-domain position information within the burst set, and also correspond to specific SSB transmission beam information. SSBs with the same SSB index can be considered to have a QCL relationship, corresponding to the types ‘QCL-Type A’ and ‘QCL-Type D’. In other words, SSBs with the same SSB index experience the same or similar large-scale parameters of the channel, including Doppler shift, Doppler spread, average delay, delay spread, and spatial Rx parameters. The UE can assume that the network device uses the same beam to transmit the SSBs. SSBs corresponding to different SSB indexes are not considered to have a QCL relationship, because they may come from different transmission beams of the network device and experience different channel transmission characteristics.

In the initial access procedure, the terminal device attempts to search for an SSB(s) by using predefined possible time-frequency positions of SSBs. The terminal device then uses the detected SSB to obtain time and frequency synchronization, radio frame timing, and a cell ID (e.g., physical-layer cell ID). The network device indicates the SSB actually transmitted within one SSB burst set, for example, through indication information in system information. Accordingly, after accessing the network, the terminal device can determine the SSB actually transmitted within one SSB burst set by using the indication information sent by the network device.

In some embodiments, when receiving a physical downlink shared channel (PDSCH), the terminal device shall perform rate matching around candidate positions that may be used to transmit the SSB. That is, if the terminal device receives scheduling information indicating reception of a first PDSCH on a first time-frequency resource, and a second time-frequency resource included in the first time-frequency resource is used to transmit the SSB or the second time-frequency resource may be used to transmit the SSB, the terminal device shall assume that the second time-frequency resource is not used for PDSCH transmission. The unit of the resource unit included in the second time-frequency resource may be a resource element (RE) or a physical resource block (PRB).

In some embodiments, the terminal device can also obtain the resource configuration in the random access procedure according to the received system information of the cell. The random access is a very important procedure in the initial access procedure. In addition to establishing the radio resource control (RRC) connection, maintaining the uplink synchronization, and cell switching, the random access procedure also undertakes functions such as beam management and the request of the system information.

The resource configuration in the random access procedure may include the physical random access channel (PRACH) resource configuration, also known as PRACH occasion (RO). RO is the time-frequency resource used to carry the random access preamble. If the UE supports two-step RACH transmission, the resource configuration in the random access procedure can also include physical uplink shared channel (PUSCH) resource configuration, also known as PUSCH occasion (PO). Message A (MsgA) in the two-step RACH includes MsgA Preamble and MsgA PUSCH. RO is the time-frequency resource used to carry the MsgA Preamble, and PO is the time-frequency resource used to carry the MsgA PUSCH.

The NR system features in supporting downlink multi-beam. Before the network device communicates with the terminal device, the network device needs to know the beam serving the terminal device, so the network device can set the appropriate beam direction for subsequent data transmission. Since the PRACH in the random access procedure is the first information sent by the terminal device to the network device, the PRACH can be used to report the beam where the terminal device is located. As an implementation, the beam where the terminal device is located can be determined according to a mapping relationship between SSBs and ROs.

In the NR system, the following mapping relationships between SSBs and ROs are supported: 1) one-to-one mapping, 2) many-to-one mapping, and 3) one-to-many mapping. FIG. 3 illustrates a schematic diagram of a mapping relationship between SSBs and ROs, where the SSB is in the initial bandwidth part (BWP) of the downlink (DL), and the RO is on the initial BWP of the uplink (UL). For example, the SSB is on the DL BWP #0 in FIG. 3, and the RO is on the UL BWP #0 in FIG. 3. In the example of FIG. 3, the SSB and the RO of the same shape have a mapping relationship. For example, SSB #0 has a mapping relationship with RO #O, SSB #1 has a mapping relationship with RO #1, and so on.

Before initiating random access, the terminal device measures and evaluates the signal quality of the cell and the signal strength of each SSB in the cell. If the detected signal strengths of the SSBs exceed a threshold, the terminal device determines the SSB with the strongest or stronger signal (for example, SSB #1 is determined by the terminal device to be the SSB with the strongest signal). Then, according to the mapping relationship between SSBs and ROs, the terminal device determines the RO corresponding to the SSB with the strongest or stronger signal, and transmits the preamble on the RO. For example, if the terminal device determines SSB #1 to be the SSB with the strongest signal, the terminal device can determine the PRACH occasion corresponding to SSB #1 as RO #1 according to the mapping relationship between SSBs and ROs, and transmit the preamble on RO #1. Subsequently, if the network device successfully receives the preamble, the network device can determine the SSB selected by the terminal device based on the resource information for the successful reception of the preamble. For example, according to the association, the network device can determine that the preamble is associated with SSB #1, and thus can determine the beam information corresponding to subsequent communication according to SSB #1.

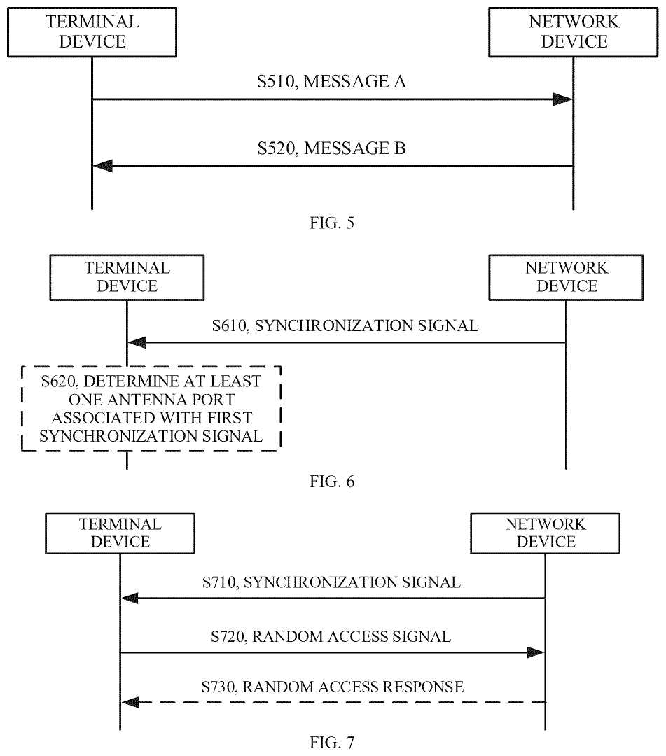

For ease of understanding, the processes of a 4-step random access procedure and a 2-step random access procedure are respectively introduced below with reference to FIG. 4 and FIG. 5.

FIG. 4 is a flow chart of a 4-step random access procedure. As illustrated in FIG. 4, the 4-step random access procedure may include S410 to S440.

At S410 (first step), the terminal device sends a random access preamble (also called message 1, Msg1, etc.) to the network device on a PRACH resource in an initial uplink BWP.

At S420 (second step), after Msg1 is detected, the network device sends a PDCCH scrambled with a random access radio network temporary identifier (RA-RNTI) to the terminal device. The PDCCH can be sent through the resource in the Type1-PDCCH common search space (CSS) in an initial downlink BWP. The PDSCH scheduled by the PDCCH can include a random access response (RAR, also known as message 2, Msg2, etc.) corresponding to the preamble sent by the terminal device.

Accordingly, the terminal device uses the RA-RNTI on the Type 1-PDCCH CSS in the initial downlink BWP to detect the PDCCH. After the PDCCH is detected, the terminal device determines whether the RAR sent by the network device to the terminal device is included according to the PDSCH scheduled by the PDCCH. The RAR may include information such as the uplink grant for message 3 (Msg3), the timing advance command (TA command), and the temporary cell RNTI (TC-RNTI). In some embodiments, the Type 1-PDCCH CSS is configured by the network device through the system information and/or higher-layer parameters.

At S430 (third step), after the RAR is received, the terminal device transmits message 3 (Msg3) on the uplink resource indicated by the RAR. In some embodiments, S430 supports HARQ retransmission. That is, if the network device does not correctly receive Msg3, the network device can schedule the retransmission of Msg3 using a TC-RNTI-scrambled PDCCH. The PDCCH can carry DCI format 0_0.

At S440 (fourth step), the network device sends message 4 (Msg4) to the terminal device, where message 4 includes a contention resolution message. In some embodiments, S430 supports HARQ retransmission. If the terminal device does not correctly receive Msg4, the network device may use the TC-RNTI-scrambled PDCCH to schedule the retransmission of Msg4. The PDCCH may carry DCI format 1_0. If the terminal device correctly receives Msg4 and determines that Msg4 is the message for the terminal device, the random access procedure for the terminal device is successful. Otherwise, the random access procedure fails. The terminal device needs to initiate the random access procedure again from the first step.

FIG. 5 is a flow chart of a 2-step random access procedure. As illustrated in FIG. 5, the 2-step random access procedure may include S510 and S520.

At S510 (first step), the terminal device sends message A (MsgA) to the network device on the RO and PO in the initial uplink BWP, where the MsgA includes the MsgA Preamble and the MsgA PUSCH.

At S520 (second step), after MsgA is detected, the network device sends a PDCCH scrambled with MsgB-RNTI to the terminal device through the resource in the Type 1-PDCCH CSS in the initial downlink BWP. The PDSCH scheduled by the PDCCH may include a random access response (also called message B, MsgB, etc.) corresponding to MsgA sent by the terminal device.

If the network device only detects the MsgA Preamble and does not receive the MsgA PUSCH, the PDSCH scheduled by the PDCCH may include the fallback RAR corresponding to the MsgA Preamble sent by the terminal device. Accordingly, the terminal device uses the MsgB-RNTI to detect the PDCCH on the Type1-PDCCH CSS in the initial downlink BWP. After the PDCCH is detected, the terminal device determines whether the success RAR or fallback RAR sent by the network device to the terminal device is included according to the PDSCH scheduled by the PDCCH.

If the terminal device correctly receives the success RAR, the terminal device will feed back ACK information to the network device, and the random access procedure of the terminal device will be successful. Alternatively, if the terminal device receives the fallback RAR, the terminal device will send Msg3 on the uplink resource indicated by the fallback RAR after the fallback RAR is received, and the 2-step random access procedure will fall back to the 4-step random access procedure. Alternatively, if the terminal device does not receive any RAR, the random access procedure fails, and the terminal device needs to initiate the random access procedure again from the first step.

As mentioned earlier, with the advancement of communication technology, communication systems are placing higher demands on wireless network coverage. Some communication systems (such as B5G, 6G systems, and other future evolved communication systems) consider introducing distributed antenna systems, to quickly and flexibly build wireless networks that meet user needs. However, how terminal devices and network devices establish communication connections in the scenario of the distributed antenna system is currently unclear.

For the above problems, embodiments of the present application provide a wireless communication method, a terminal device, and a network device. The terminal device can determine an antenna port associated with a first synchronization signal according to the detected first synchronization signal. Thus, it is beneficial for the terminal device to subsequently establish a connection with the network device on the antenna port associated with the first synchronization signal, thereby facilitating the improvement of data transmission throughput and the improvement of communication reliability and efficiency.

Before introducing the technical solutions of the embodiments of the present application, for ease of understanding, relevant concepts of the distributed antenna system involved in the embodiments of the present application are first introduced.

In the embodiment of the present application, a channel or signal can be transmitted through the antenna port. For example, the channel or signal between the network device and the terminal device can be transmitted through the AP. Typically, for data transmission, one antenna port can be used to transmit one data stream. Communication between the network device and the terminal device can be carried out through one or more antenna ports.

In some embodiments, one antenna port may correspond to one or a set of physical antennas.

In some embodiments, multiple antenna ports used for communication transmission between the network device and the terminal device may be distributed antenna ports. For example, at least two antenna ports among the multiple antenna ports are distributed antenna ports, or any two antenna ports among the multiple antenna ports are distributed antenna ports.

Taking distributed antenna ports as an example, in some embodiments, multiple antenna ports or multiple antenna port sets (antenna port clusters) used for communication transmission can be geographically separated. In other words, the channels or signals transmitted through the multiple antenna ports or multiple antenna port sets used for communication transmission do not have a QCL relationship.

In some embodiments, the fact that the channels or signals transmitted through the multiple antenna ports used for communication transmission do not have the QCL relationship may include the following. The channels or signals transmitted through at least two of the multiple antenna ports do not have the QCL relationship, or channels or signals transmitted through any two of the multiple antenna ports do not have the QCL relationship. In other words, the characteristics of the distributed antenna ports may include the following. The channels or signals transmitted through at least two of the multiple antenna ports do not have the QCL relationship, or channels or signals transmitted through any two of the multiple antenna ports do not have the QCL relationship.

Taking the QCL relationship associated with the distributed antenna port as a first QCL relationship as an example, in some embodiments, the characteristics of the distributed antenna ports may include the following. The channels or signals transmitted through at least two antenna ports among the multiple antenna ports do not have the first QCL relationship, or the channels or signals transmitted through any two antenna ports among the multiple antenna ports do not have the first QCL relationship.

The large-scale parameters of the channel associated with the first QCL relationship type are not limited in the embodiments of the present application. For example, the large-scale parameters of the channel associated with the first QCL relationship type may include one of the following: {Doppler shift, Doppler spread, average delay, delay spread}, {Doppler shift, Doppler spread, average delay, delay spread, spatial Rx parameter}, {Doppler shift, Doppler spread}, {Doppler shift, Doppler spread, spatial Rx parameter}, {Doppler shift, average delay}, {Doppler shift, average delay, spatial Rx parameter}, or {spatial Rx parameter}.

In some embodiments, multiple antenna ports used for communication transmission between the network device and the terminal device may be centralized antenna ports. For example, any two antenna ports among the multiple antenna ports are centralized antenna ports.

Taking centralized antenna ports as an example, in some embodiments, channels or signals transmitted through multiple antenna ports or multiple antenna port sets used for communication transmission have the QCL relationship. For example, the channels or signals transmitted through any two antenna ports among the multiple antenna ports used for communication transmission have the QCL relationship.

Taking the QCL relationship associated with the centralized antenna port as a second QCL relationship as an example, in some embodiments, the characteristics of the centralized antenna ports may include the following. The channels or signals transmitted through any two antenna ports among the multiple antenna ports have the second QCL relationship.

The large-scale parameters of the channel associated with the second QCL relationship type are not limited in the embodiments of the present application. For example, the large-scale parameters of the channel associated with the second QCL relationship type may include one of the following: {Doppler shift, Doppler spread, average delay, delay spread}, {Doppler shift, Doppler spread, average delay, delay spread, spatial Rx parameter}, {Doppler shift, Doppler spread}, {Doppler shift, Doppler spread, spatial Rx parameter}, {Doppler shift, average delay}, {Doppler shift, average delay, spatial Rx parameter}, or {spatial Rx parameter}.

In some embodiments, the first QCL relationship type and the second QCL relationship type are associated with the same large-scale parameters of the channel. For example, the large-scale parameters of the channel associated with the first QCL relationship type and the second QCL relationship type are both {Doppler shift, Doppler spread, average delay, delay spread, spatial Rx parameter}.

In some embodiments, the first QCL relationship type and the second QCL relationship type are associated with different large-scale parameters of the channel. For example, the large-scale parameters of the channel associated with the first QCL relationship type are {Doppler shift, average delay, spatial Rx parameter}, and the large-scale parameters of the channel associated with the second QCL relationship type are {Doppler shift, Doppler spread, average delay, delay spread, spatial Rx parameter}.

In some embodiments, the network for wireless communication may include one or more antenna port sets, where the antenna port set may also be referred to as antenna port cluster. One antenna port set may include one or more antenna ports, and the one or more antenna ports in the antenna port set may be used to transmit channels or signals, such as communication signals between the network device and the terminal device.

In some embodiments, one antenna port set may be a distributed antenna port set. In other words, one antenna port set includes multiple antenna ports, where the multiple antenna ports include at least two antenna ports that do not have the first QCL relationship. For example, at least two antenna ports included in one antenna port set do not have the first QCL relationship, or any two antenna ports included in one antenna port set do not have the first QCL relationship.

In some embodiments, one antenna port set may be a centralized antenna port set. In other words, the antenna ports included in one antenna port set have the second QCL relationship. For example, any two antenna ports included in an antenna port set have the second QCL relationship.

In some embodiments, one antenna port set may include multiple antenna ports that are geographically close to each other. Optionally, the multiple antenna ports may be distributed antenna ports, or the multiple antenna ports may be centralized antenna ports, or some of the multiple antenna ports may be distributed antenna ports and some other of the multiple antenna ports may be centralized antenna ports.

It should be understood that in embodiments of the present application, the communication network may include one or more antenna ports, and the channel or signal may be transmitted through the one or more antenna ports. Alternatively, the communication network may include one or more antenna port sets, and the channel or signal may be transmitted through the one or more antenna port sets.

It should be understood that in the embodiments of the present application, the frequency resources used for channel or signal transmission may be referred to as carriers. For example, the frequency resources used for downlink channel or signal transmission may be referred to as downlink carriers, and the frequency resources used for uplink channel or signal transmission may be referred to as uplink carriers. The frequency resources contained in the carrier are not limited in the embodiments of the present application. For example, the carrier may include a segment of consecutive frequency resources for channel or signal transmission, or the carrier may include multiple segments of inconsecutive frequency resources for channel or signal transmission. The units of the frequency resources contained in the carrier are not limited in the embodiments of the present application. As an example rather than limitation, the unit of the frequency resource may be resource block, resource element, etc.

It should be understood that in embodiments of the present application, the carrier and the cell may not have an association, for example, the carrier is not associated with the cell. Alternatively, the carrier may be associated with the cell. For example, “downlink carrier” can be replaced with “downlink cell” and “uplink carrier” can be replaced with “uplink cell”.

As can be seen from the above description, in a distributed antenna system, the multiple antenna ports or antenna port sets used for communication transmission are geographically separated. In other words, the multiple antenna ports or antenna port sets used for communication transmission do not have the QCL relationship. Furthermore, the concept of cells may no longer exist in future communication systems. Therefore, as a possible implementation, the terminal device can select one or more antenna ports (or antenna port sets) that are closer to the terminal device according to the geographic location of the terminal device to provide service for the terminal device, thereby achieving better data transmission throughput. However, in these scenarios, how to establish a communication connection between the terminal device and the network device is a problem to be solved.

According to the above introduction to concepts such as the distributed antenna system and the distributed antenna port, the following describes the method embodiments of the present application. It should be noted that the present embodiments do not limit the application scenarios of the technical solutions of the present application. For example, the present application can be applied to the initial access procedure of the terminal device, such as the 4-step random access procedure or the 2-step random access procedure. Alternatively, the present embodiments can be applied to TN scenarios or NTN scenarios.

FIG. 6 is a schematic flow chart of a wireless communication method provided in an embodiment of the present application. The method illustrated in FIG. 6 is described from the perspective of interaction between a terminal device and a network device. The terminal device and network device may be, for example, any of the terminal devices and network devices described in FIGS. 1A to 1C, or any of the terminal devices and network devices described in FIGS. 2A to 2C.

The method illustrated in FIG. 6 may include S610. At S610, a terminal device detects a synchronization signal sent by a network device.

The network device may send one or more synchronization signals. Accordingly, the terminal device may detect the one or more synchronization signals sent by the network device, to perform subsequent operations according to the detected synchronization signals, such as performing random access.

In some embodiments, the synchronization signal sent by the network device may include a synchronization signal/PBCH block (SSB). In other words, the network device may send the synchronization signal to the terminal device in the form of the SSB, so that the terminal device performs uplink synchronization according to the SSB. However, the embodiments of the present application are not limited to this. In some embodiments, the synchronization signal sent by the network device may be in the form other than the SSB, as long as the synchronization signal is used for uplink synchronization for the terminal device. For example, the synchronization signal may be a synchronization signal such as PSS, SSS, or the synchronization signal may be a synchronization signal with other names.

That is, in the embodiment of the present application, the synchronization signal sent by the network device may be the same as the SSB or synchronization signal in the existing system, or may be different from the SSB or synchronization signal in the existing system. The embodiment of the present application is not limited to this.

In some embodiments, the synchronization signal (or one or more synchronization signals) sent by the network device may include a first synchronization signal. The first synchronization signal may be any one or any multiple synchronization signals among the synchronization signals sent by the network device.

In some embodiments, the first synchronization signal may include the synchronization signal with the strongest received signal strength detected by the terminal device. For example, if the synchronization signals detected by the terminal device include SSB 0, SSB 1, and SSB 2, and SSB 1 has the strongest received signal strength, then the first synchronization signal may include SSB 1.

In some embodiments, the first synchronization signal may include a synchronization signal whose received signal strength detected by the terminal device exceeds a certain threshold. For example, the first synchronization signal may include a synchronization signal whose received signal strength detected by the terminal device exceeds −50 dBm. Assuming that the synchronization signals detected by the terminal device include SSB 0, SSB 1, and SSB 2, where the received signal strengths of SSB 0 and SSB 1 exceed the threshold (e.g., −50 dBm), the first synchronization signal may include SSB 0 and SSB 1.

In some embodiments, the first synchronization signal is sent according to an association between synchronization signals and the antenna ports.

In some embodiments, the first synchronization signal may be used to determine at least one antenna port associated with the first synchronization signal. For example, the terminal device may determine the at least one antenna port associated with the first synchronization signal according to the detected first synchronization signal.

As an implementation, the terminal device and/or network device may determine the at least one antenna port associated with the first synchronization signal according to an association between synchronization signals and antenna ports. That is, an association (or mapping relationship, correspondence, etc.) may exist between synchronization signals and antenna ports. According to the association, the terminal device and/or network device may determine the antenna port associated with a certain synchronization signal or determine the synchronization signal associated with a certain antenna port. A detailed description of the association between synchronization signals and antenna ports is provided below and is not further elaborated here.

For example, after detecting the first synchronization signal, the terminal device determines the antenna port associated with the first synchronization signal according to the first synchronization signal. In some embodiments, referring to FIG. 6, the method provided in the embodiment of the present application may further include S620, which is an optional step.

At S620, after detecting the first synchronization signal, the terminal device determines the at least one antenna port associated with the first synchronization signal according to the first synchronization signal. In other words, the at least one antenna port associated with the first synchronization signal can be explicitly or implicitly determined (or indicated) by the first synchronization signal.

As an implementation, the at least one antenna port associated with the first synchronization signal is determined according to the first synchronization signal as follows. An identifier of the at least one antenna port associated with the first synchronization signal is determined according to the first synchronization signal.

The implementation of determining the at least one antenna port associated with the first synchronization signal according to the first synchronization signal is not specifically limited in embodiments of the present application. For example, the identifier of the at least one antenna port associated with the first synchronization signal can be determined according to one or more of the following information: an index of the first synchronization signal, a synchronization signal sequence corresponding to the first synchronization signal, or information transmitted over a downlink channel associated with the first synchronization signal.

As an example, the identifier of the at least one antenna port associated with the first synchronization signal can be determined according to the index of the first synchronization signal. For example, when the association between synchronization signals and antenna ports is indicated by the index of the synchronization signal and the identifier of the antenna port, the identifier of the at least one antenna port associated with the first synchronization signal can be determined according to the index of the first synchronization signal and the association. Assuming that the index of the first synchronization signal is x0, the identifier of the at least one antenna port determined according to the index of the first synchronization signal may be x0, or may be other identifiers, as long as the identifier is determined according to the index of the first synchronization signal.

As another example, the identifier of the at least one antenna port associated with the first synchronization signal can be determined according to the synchronization signal sequence corresponding to (associated with) the first synchronization signal. The type of the synchronization signal sequence corresponding to the first synchronization signal is not limited in embodiment of the present application. Exemplarily, the synchronization signal sequence corresponding to the first synchronization signal can include a primary synchronization signal sequence and/or a secondary synchronization signal sequence. In this case, the identifier of the at least one antenna port associated with the first synchronization signal can be determined according to the synchronization signal sequence of the first synchronization signal as follows. The identifier of the at least one antenna port associated with the first synchronization signal is determined according to the primary synchronization signal sequence and the secondary synchronization signal sequence of the first synchronization signal. The identifier of the at least one antenna port associated with the first synchronization signal is determined according to the primary synchronization signal sequence of the first synchronization signal. The identifier of the at least one antenna port associated with the first synchronization signal is determined according to the secondary synchronization signal sequence of the first synchronization signal. As an implementation, the identifier of the at least one antenna port associated with the first synchronization signal can be determined according to the synchronization signal sequence ID of the first synchronization signal, for example, according to the primary synchronization signal sequence ID and the secondary synchronization signal sequence ID of the first synchronization signal, or according to the primary synchronization signal sequence ID of the first synchronization signal, or according to the secondary synchronization signal sequence ID of the first synchronization signal, etc.

As another example, the identifier of the at least one antenna port associated with the first synchronization signal can be determined according to the index of the first synchronization signal, the information transmitted over the downlink channel associated with the first synchronization signal, and so on.

In some embodiments, a transmission position of the first synchronization signal is predefined. For example, the transmission position of the first synchronization signal is predefined in N time units, where N is a positive integer.

The specific length of the N time units is not limited in the embodiments of the present application. In some embodiments, the N time units may be a radio frame. In some embodiments, the N time units may be a synchronization signal transmission period. In other words, the transmission position of the first synchronization signal may be predefined within one radio frame or one synchronization signal transmission period.

The units of time units are not limited in the embodiments of the present application. In some embodiments, the units of time units mentioned in the embodiments of the present application may be milliseconds, seconds, microseconds, etc. In some embodiments, the time units mentioned in the embodiments of the present application may be frames, half-frames, time slots, symbols, etc. In some embodiments, the time unit mentioned in the present application may be a time unit determined according to a subcarrier spacing, for example, a time unit determined according to a specific subcarrier spacing (such as a subcarrier spacing of a synchronization signal) or a predefined subcarrier spacing.

In some embodiments, the terminal device can determine the boundaries of the N time units according to the detected first synchronization signal. Taking the N time units as one radio frame as an example, assuming that the length of one radio frame includes N time units, and starting from the first time unit of the N time units, each time unit includes two synchronization signals (such as SSBs), when the terminal device finds SSB 0 or SSB 1 after searching, the terminal device can determine that the time unit carrying SSB 0 or SSB 1 is the first time unit in one radio frame, thereby determining the boundary of the radio frame and obtaining the radio frame timing.

In some embodiments, the at least one antenna port associated with the first synchronization signal may be determined according to predefined or preconfigured information. For example, the at least one antenna port associated with the first synchronization signal may be determined according to a predefined or preconfigured association, and the predefined or preconfigured association may be used to indicate the association between synchronization signals and antenna ports.

In embodiments of the present application, the terminal device can determine the antenna port associated with the first synchronization signal according to the detected first synchronization signal. Thus, it is beneficial for the terminal device to subsequently establish a connection with the network device on the antenna port associated with the first synchronization signal, thereby facilitating the improvement of data transmission throughput and the improvement of communication reliability and efficiency.

FIG. 7 is a schematic flow chart of a wireless communication method provided in another embodiment of the present application. The method illustrated in FIG. 7 may include S710 and S720, which are described below.

At S710, a terminal device detects a synchronization signal sent by a network device. For example, the terminal device detects one or more synchronization signals sent by the network device. The one or more synchronization signals sent by the network device include a first synchronization signal, and the first synchronization signal may be one or more synchronization signals detected by the terminal device.

For a detailed description of S710, reference is made to the above description of S610, which will not be repeated here for the sake of brevity.

At S720, the terminal device sends a random access signal in at least one random access occasion.

In some embodiments, the at least one random access occasion for sending the random access signal is determined according to an association between random access occasions and antenna ports. As an implementation, the terminal device may determine, according to the detected first synchronization signal, at least one antenna port associated with the first synchronization signal, and then determine the at least one random access occasion according to the at least one antenna port associated with the first synchronization signal.

In some embodiments, the at least one random access occasion for sending the random access signal is determined according to an association between random access occasions and synchronization signals. As an implementation, the at least one random access occasion for sending the random access signal is determined according to the first synchronization signal detected by the terminal device and the association between random access occasions and synchronization signals.

For the association between random access occasions and antenna ports, and the association between random access occasions and synchronization signals, reference can be found in the following introduction, which will not be described in detail here.

In some embodiments, the random access signal sent by the terminal device may include, for example, a preamble.

In some embodiments, the random access signal sent by the terminal device may include, for example, a preamble and uplink information.

In some embodiments, if the first synchronization signal detected or determined by the terminal device is one synchronization signal, the terminal device may initiate random access through the random access occasion set associated with the antenna port associated with the one synchronization signal. For example, the terminal device may initiate random access through the random access occasion set associated with the antenna port set associated with the one synchronization signal. Alternatively, the terminal device may initiate random access through the random access occasion set associated with the antenna port associated with the one synchronization signal.

In some embodiments, if the first synchronization signal detected or determined by the terminal device is multiple synchronization signals, the terminal device may initiate random access through at least one random access occasion set from among multiple random access occasion sets associated with antenna ports associated with the multiple synchronization signals. For example, the terminal device may initiate random access through at least one random access occasion set from among multiple random access occasion sets associated with multiple antenna port sets associated with the multiple synchronization signals. Alternatively, the terminal device may initiate random access through at least one random access occasion set from among multiple random access occasion sets associated with multiple antenna ports associated with the multiple synchronization signals.

Referring to FIG. 7, in some embodiments, the method provided in the embodiment of the present application may further include S730. At S730, the network device sends a random access response to the terminal device.

In some embodiments, the random access response is in response to the random access signal sent by the terminal device.

In some embodiments, the random access response is sent by the network device through the at least one antenna port associated with the first synchronization signal. In some embodiments, the random access response may be sent by the network device through an antenna port in an antenna port set to which the at least one antenna port associated with the first synchronization signal belongs.

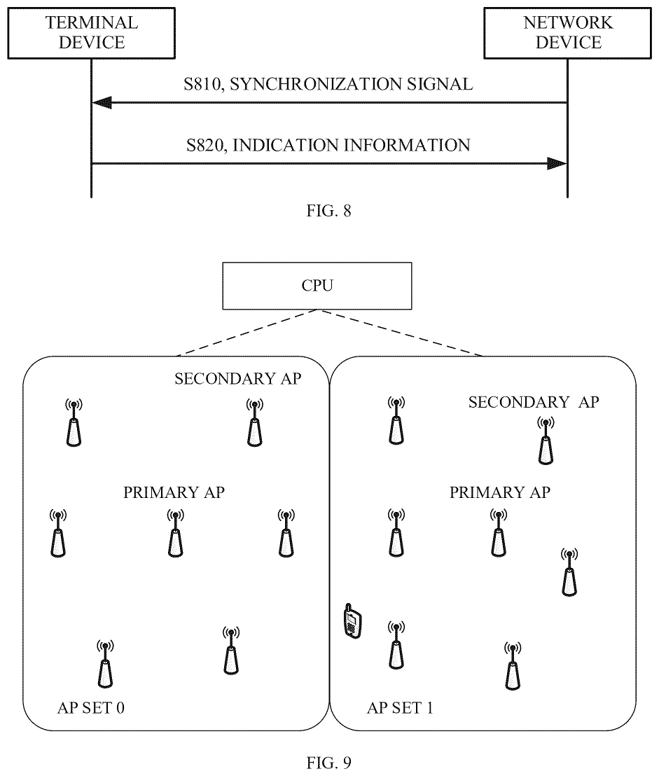

FIG. 8 is a schematic flow chart of a wireless communication method provided in yet another embodiment of the present application. The method illustrated in FIG. 8 may include S810 and S820, which are described below.

At S810, a terminal device detects a synchronization signal sent by a network device. For example, the terminal device detects one or more synchronization signals sent by the network device. The one or more synchronization signals sent by the network device include a first synchronization signal, and the first synchronization signal may be one or more synchronization signals detected by the terminal device.

For a detailed description of S810, reference is made to the above description of S610, which will not be repeated here for the sake of brevity.

At S820, the terminal device sends indication information (such as the third indication information mentioned below) to the network device. The indication information is used to determine (or indicate) the antenna port selected by the terminal device and/or the synchronization signal selected by the terminal device. For example, the indication information can be used to determine M antenna ports and/or N synchronization signals selected by the terminal device, where N and M are positive integers.

In some embodiments, the indication information is used to determine the M antenna ports selected by the terminal device, which may have the following meaning. The indication information may be used to indicate identifiers of the M antenna ports selected by the terminal device.

In some embodiments, M may be predefined or preconfigured. In some embodiments, M may be determined according to a threshold value (e.g., a third threshold value), and the threshold value may be predefined or preconfigured.

In some embodiments, the M antenna ports selected by the terminal device can be M antenna ports corresponding to signal strengths ranking from strong to weak. That is, the M antenna ports selected by the terminal device can be M antenna ports with the strongest signal strengths among the multiple antenna ports associated with the terminal device.

In some embodiments, the M antenna ports selected by the terminal device may be M antenna ports that are greater than or equal to a certain threshold value (e.g., a third threshold value). That is, M is determined according to the threshold value.

In some embodiments, if the number of antenna ports determined by the terminal device is less than M, the indication bit may be a preset value or a padding value.

In some embodiments, the threshold value (e.g., the third threshold value) used to determine M may be a value indicating a signal strength. For example, the threshold value may be a signal strength greater than −50 dBm.

In some embodiments, the indication information is used to determine the N synchronization signals selected by the terminal device, which may have the following meaning. The indication information may be used to indicate indexes of the N synchronization signals selected by the terminal device.

In some embodiments, N may be predefined or preconfigured. In some embodiments, N may be determined according to a threshold value (e.g., a fourth threshold value), and the threshold value may be predefined or preconfigured.

In some embodiments, the N synchronization signals selected by the terminal device may be N synchronization signals with received signal strengths ranking from strong to weak. That is, the N synchronization signals selected by the terminal device may be N synchronization signals with the strongest signal strengths detected by the terminal device.

In some embodiments, the N synchronization signals selected by the terminal device may be N synchronization signals greater than or equal to a certain threshold value (e.g., a fourth threshold value). In other words, N is determined according to the threshold value.

In some embodiments, if the number of synchronization signals determined by the terminal device is less than N, the indication bit may be a preset value or a padding value.

In some embodiments, the threshold value (e.g., the fourth threshold value) used to determine N may be a value indicating a received signal strength. For example, the threshold value may be a received signal strength greater than −50 dBm.

The manner of carrying the indication information in S820 is not limited in embodiments of the present application. For example, the indication information may be carried in one or more of the following transmissions: a random access signal, an uplink transmission of random access response scheduling, or an uplink transmission after completion of the random access procedure.

As an example, the indication information may be carried in a preamble. As another example, the indication information may be carried in Msg 3. As yet another example, the indication information may be carried in Msg 5 after the random access procedure is completed. As yet another example, the indication information may be carried in uplink scheduling after the random access procedure is completed. As yet another example, the indication information may be carried in uplink information in the 2-step random access procedure, etc.

In some embodiments, before detecting the synchronization signal sent by the network device, the terminal device may attempt to search for the synchronization signal according to predefined possible time-frequency positions of the synchronization signal.

In some embodiments, after the terminal device detects the first synchronization signal, the terminal device can obtain time and frequency synchronization and timing according to the detected first synchronization signal, and determine the at least one antenna port associated with the first synchronization signal.

It should be noted that the processes of the wireless communication methods mentioned in the above embodiments can be combined, such as partially or completely, and the embodiments of the present application are not limited herein. For example, the wireless communication method provided in the embodiments of the present application may include the above S610, S620, and S720. Alternatively, the wireless communication method provided in the embodiments of the present application may include the above S610, S720, and S820.

It should also be noted that, in combining the steps of various embodiments, the order in which the steps are executed are not limited in the embodiments of the present application. For example, if the wireless communication method includes S610, S620, and S720 described above, S720 may be executed after S620. If the wireless communication method includes S610, S720, and S820 described above, S820 may be executed after S720, before S720, or simultaneously with S720.

The above describes the steps of the wireless communication method. The following describes in detail the various associations involved in the embodiments of the present application. The associations mentioned below are related to the architecture of the distributed antenna system. In other words, the associations mentioned in the embodiments of the present application may vary under different architectures of the distributed antenna system. To facilitate understanding, the following first describes the architectures of two distributed antenna systems involved in the embodiments of the present application.

FIG. 9 is a schematic diagram of a network structure based on a distributed antenna system provided in embodiments of the present application. In the network illustrated in FIG. 9, the communication network includes one or more antenna port sets. As an example rather than limitation, FIG. 9 illustrates an example in which two antenna port sets are included in the communication network. As an example, the communication network includes antenna port set 0 and antenna port set 1, and each antenna port set includes multiple antenna ports within a certain geographical area. The number of antenna ports included in different antenna port sets can be the same or different, and the present application does not limit this. In the example, the different antenna ports included in one antenna port set are at different geographical locations. So it can be considered that any two antenna ports in the antenna port set do not have a first QCL relationship, or in other words, the antenna ports included in the antenna port set are distributed antenna ports.

In some embodiments, the antenna ports included in one antenna port set can include two types: primary antenna ports and secondary antenna ports. The number of primary antenna ports included in one antenna port set can be one or more, and the number of secondary antenna ports included in one antenna port set can also be one or more. By way of explanation rather than limitation, in FIG. 9, antenna port set 0 and antenna port set 1 each include one primary antenna port, and all antenna ports other than the primary antenna port are secondary antenna ports.

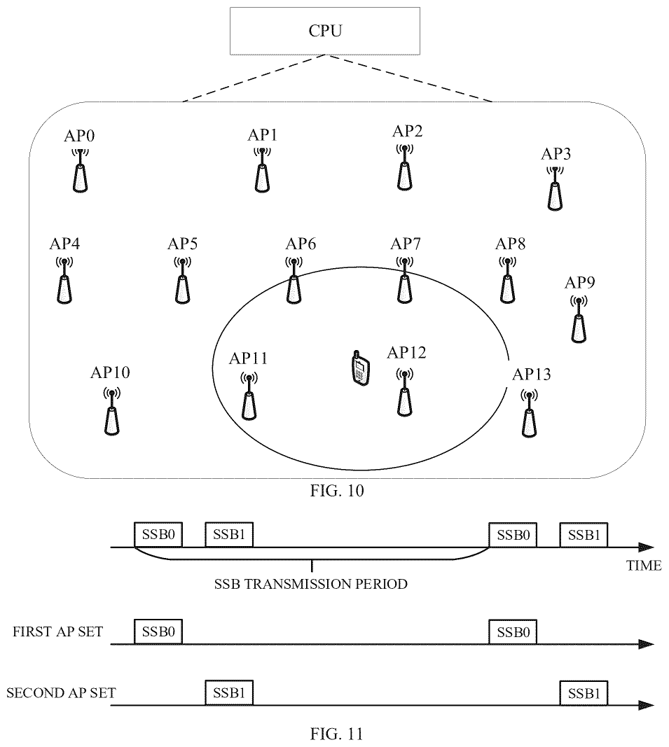

FIG. 10 is another schematic diagram of a network structure based on a distributed antenna system provided in embodiments of the present application. In the network illustrated in FIG. 10, the communication network includes one or more antenna ports. As an example rather than limitation, FIG. 10 illustrates an example in which 14 antenna ports are included in the communication network. As an example, the communication network includes multiple antenna ports within a certain geographical area. In some embodiments, the number of physical antennas associated with different antenna ports included in the communication network may be the same or different, and the present application does not limit this. In the example, the geographical locations of different antenna ports are different. So it can be considered that any two antenna ports do not have a first QCL relationship, or in other words, the antenna ports included in the communication network are distributed antenna ports.

In some embodiments, the antenna ports included in the communication network illustrated in FIG. 10 do not distinguish between the primary antenna port and the secondary antenna port. However, the embodiments of the present application are not limited thereto. In some embodiments, the antenna ports included in the communication network may also include primary antenna ports and secondary antenna ports.

The following describes the wireless communication methods involved in the embodiments of the present application under two architectures of distributed antenna systems, respectively, in conjunction with Embodiment 1 and Embodiment 2. Embodiment 1 can be applied to the network architecture illustrated in FIG. 9, and Embodiment 2 can be applied to the network architecture illustrated in FIG. 10.

### Embodiment 1: Synchronization Signal Associated with Antenna Port Set

To enable a terminal device to access a wireless communication network based on a distributed antenna system, a network device may send a synchronization signal through an antenna port in an antenna port set. Taking the communication network illustrated in FIG. 9 as an example, the network device may send a synchronization signal through an antenna port in antenna port set 0 and/or antenna port set 1, as illustrated in FIG. 11.

It should be understood that the synchronization signal sent by the network device may refer to an SSB or other forms of synchronization signal. In some embodiments, the synchronization signal sent by the network device may be the same as or different from the synchronization signal in the existing system, and the present application is not limited to this.

After the network device sends the synchronization signal, the terminal device can detect the synchronization signal sent by the network device. The synchronization signal sent by the network device can include a first synchronization signal, and the first synchronization signal can be, for example, any one or more synchronization signals among the synchronization signals sent by the network device.

In some embodiments, the first synchronization signal may be, for example, a synchronization signal with the strongest received signal strength detected by the terminal device.

In some embodiments, the first synchronization signal may be, for example, a synchronization signal whose received signal strength detected by the terminal device exceeds a first threshold. It should be noted that the first threshold is not limited in embodiments of the present application. The first threshold may be a value that is set according to actual conditions. For example, the first threshold is −50 dBm. It should also be noted that the embodiment of the present application does not limit the configuration method of the first threshold. For example, the first threshold may be predefined or preconfigured, or may be configured by the network device through high-layer signaling (such as RRC signaling), or may be determined based on the implementation of the terminal device.

In some embodiments, after the terminal device detects the first synchronization signal, at least one antenna port associated with the first synchronization signal can be determined according to the first synchronization signal.

In some embodiments, the at least one antenna port associated with the first synchronization signal is an antenna port(s) in a first antenna port set, where the first synchronization signal is associated with the first antenna port set.

The first antenna port set can be any antenna port set in the wireless communication network system. Taking the network system illustrated in FIG. 9 as an example, the first antenna port set can be antenna port set 0 in FIG. 9 or antenna port set 1 in FIG. 9.

The first antenna port set may include one or more antenna ports. In some embodiments, when the first antenna port set includes multiple (two or more) antenna ports, at least two of the multiple antenna ports included in the first antenna port set may be distributed antenna ports. In other words, the at least two of the multiple antenna ports included in the first antenna port set are geographically separated or do not have a first QCL relationship. In some embodiments, any two of the multiple antenna ports included in the first antenna port set are distributed antenna ports. In other words, any two of the multiple antenna ports included in the first antenna port set are geographically separated or do not have a first QCL relationship.

In some embodiments, the first synchronization signal being associated with the first antenna port set may mean that there is an association or mapping relationship between the first synchronization signal and the first antenna port set, and the first antenna port set can be determined according to the first synchronization signal or the first synchronization signal can be determined according to the first antenna port set.

In some embodiments, the association between the first synchronization signal and the first antenna port set is indicated by a first association. In other words, the first association can be used to indicate the association between synchronization signals and antenna port sets, such as indicating antenna port sets associated with different synchronization signals.

That is, in the embodiment of the present application, different antenna port sets can be associated with different synchronization signals. The association between different antenna port sets and different synchronization signals can be indicated by the first association. The first association is introduced below.

In some embodiments, the first association may indicate the association between synchronization signals and antenna port sets by indicating indexes of the synchronization signals and identifiers of the antenna port sets. For example, the first association may include: SSB 0 being associated with antenna port set 0, SSB 1 being associated with antenna port set 1, etc.

In some embodiments, in the first association, one synchronization signal may be associated with one antenna port set, that is, there may be a one-to-one correspondence between synchronization signals and antenna port sets. For example, SSB 0 is associated with antenna port set 0, and SSB 1 is associated with antenna port set 1.

In some embodiments, in the first association, one synchronization signal can be associated with multiple antenna port sets, that is, there can be a one-to-many correspondence between synchronization signals and antenna port sets. For example, SSB 0 is associated with both antenna port set 0 and antenna port set 1.

In some embodiments, in the first association, multiple synchronization signals can be associated with one antenna port set, that is, there can be a many-to-one correspondence between synchronization signals and antenna port sets. For example, both SSB 0 and SSB 1 are associated with antenna port set 0.

In some embodiments, the first association may include one or more of the following: a correspondence between one synchronization signal and one antenna port set; a correspondence between one synchronization signal and antenna port sets; a correspondence between synchronization signals and one antenna port set; a one-to-one correspondence between synchronization signals and antenna port sets; a correspondence between one synchronization-signal index and one antenna-port-set identifier; a correspondence between one synchronization-signal index and antenna-port-set identifiers; a correspondence between synchronization-signal indexes and one antenna-port-set identifier; or a one-to-one correspondence between synchronization-signal indexes and antenna-port-set identifiers.

In some embodiments, the first association may be predefined or preconfigured. For example, the first association may be predefined in a protocol. In some embodiments, the first association may be configured by the network device through high-layer signaling.

In some embodiments, the terminal device determines, according to the first synchronization signal, the at least one antenna port associated with the first synchronization signal as follows. The terminal device determines, according to the first synchronization signal, an identifier of the first antenna port set. For example, the terminal device determines, according to the first synchronization signal and the first association, the identifier of the first antenna port set associated with the first synchronization signal.

In some embodiments, the terminal device determines, according to the first synchronization signal, the at least one antenna port associated with the first synchronization signal as follows. The terminal device determines, according to the first synchronization signal, an identifier of the at least one antenna port in the first antenna port set. For example, the terminal device determines, according to the first synchronization signal and the first association, the first antenna port set associated with the first synchronization signal or the identifier of the first antenna port set, and further determines, from the first antenna port set, the identifier of the at least one antenna port in the first antenna port set (such as an identifier of a primary antenna port or an identifier of a secondary antenna port in the first antenna port set).

That is, in some embodiments, the identifier of the first antenna port set or the identifier of the at least one antenna port in the first antenna port set is determined according to the first synchronization signal. The implementation of determining the identifier of the first antenna port set or the identifier of the at least one antenna port in the first antenna port set according to the first synchronization signal is not limited in the embodiments of the present application. For example, the identifier of the first antenna port set or the identifier of the at least one antenna port in the first antenna port set can be explicitly or implicitly determined by the first synchronization signal.

As an implementation, the identifier of the first antenna port set or the identifier of the at least one antenna port in the first antenna port set can be determined according to one or more of the following information: an index of the first synchronization signal, a synchronization signal sequence corresponding to the first synchronization signal, or information transmitted in a downlink channel associated with the first synchronization signal. For a detailed description of how to determine the identifier of the first antenna port set or the identifier of the at least one antenna port in the first antenna port set by using the above information, reference is made to the previous text. For the sake of brevity, this description will not be repeated here.

As mentioned above, the first synchronization signal is sent by the network device to the terminal device. The sending of the first synchronization signal is introduced below.

In some embodiments, the first synchronization signal may be sent according to the first association. In this case, the terminal device may determine the at least one antenna port associated with the first synchronization signal according to the first synchronization signal as follows. The terminal device determines the first antenna port set according to the first synchronization signal and the first association.

In some embodiments, the first synchronization signal is sent through some antennas in the first antenna port set. For example, the first antenna port set includes antenna port 0, antenna port 1, and antenna port 2. The first synchronization signal may be sent through antenna port 0, or antenna port 1, or both antenna port 0 and antenna port 2.

In some embodiments, the first synchronization signal is transmitted via all antenna ports (every antenna port) in the first antenna port set. That is, all antenna ports in the first antenna port set are used to transmit the first synchronization signal. For example, the first antenna port set includes antenna port 0, antenna port 1, and antenna port 2, where all of antenna port 0, antenna port 1, and antenna port 2 are used to transmit the first synchronization signal.

In some embodiments, the first antenna port set may include a primary antenna port. In this case, the first synchronization signal may be sent through the primary antenna port. For example, the first antenna port set may include one or more primary antenna ports, and the one or more primary antenna ports may be used to send the first synchronization signal.

In some embodiments, the first antenna port set may include a secondary antenna port, for example, one or more secondary antenna ports. In some embodiments, the secondary antenna ports in the first antenna port set are not used to send synchronization signals, for example, the secondary antenna ports are not used to send the first synchronization signal or other synchronization signals.

In some embodiments, the primary antenna port in the first antenna port set may be used to send the synchronization signal, while the secondary antenna port in the first antenna port set may not be used to send the synchronization signal. For example, the primary antenna port may be used to send the first synchronization signal, while the secondary antenna port may not be used to send the first synchronization signal.

In some embodiments, some antenna ports in the first antenna port set are not used to send synchronization signals that are not associated with the first antenna port set. For example, if the first synchronization signal has a one-to-one correspondence with the first antenna port set, some antenna ports in the first antenna port set are not used to send synchronization signals other than the first synchronization signal. As an example, the first antenna port set includes antenna port 0, antenna port 1, and antenna port 2, and antenna port 0 is not used to send synchronization signals other than the first synchronization signal, or antenna port 0 and antenna port 1 are not used to send synchronization signals other than the first synchronization signal.

In some embodiments, all antenna ports in the first antenna port set are not used to send synchronization signals that are not associated with the first antenna port set. For example, if the first synchronization signal has a one-to-one correspondence with the first antenna port set, all antenna ports in the first antenna port set are not used to send synchronization signals other than the first synchronization signal. As an example, the first antenna port set includes antenna port 0, antenna port 1, and antenna port 2, and all of antenna port 0, antenna port 1, and antenna port 2 are not used to send synchronization signals other than the first synchronization signal.

In some embodiments, the primary antenna port and/or the secondary antenna port in the first antenna port set are not used to send synchronization signals that are not associated with the first antenna port set. For example, the primary antenna port in the first antenna port set is not used to send synchronization signals that are not associated with the first antenna port set. Alternatively, the secondary antenna port in the first antenna port set is not used to send synchronization signals that are not associated with the first antenna port set. Alternatively, both the primary antenna port and the secondary antenna port in the first antenna port set are not used to send synchronization signals that are not associated with the first antenna port set.

In some embodiments, a second association is established between the first antenna port set and the first random access occasion set, and/or the second association is established between the first synchronization signal and the first random access occasion set. At least one random access occasion in the first random access occasion set is used to transmit a random access signal (e.g., preamble).

That is, in the embodiment of the present application, different antenna port sets can be associated with different random access occasion sets. The association between different antenna port sets and different random access occasion sets can be indicated by the second association. Alternatively, in the embodiments of the present application, different synchronization signals can be associated with different random access occasion sets. The association between different synchronization signals and different random access occasion sets can be indicated by the second association. The second association is described below.

In some embodiments, the association between antenna port sets and random access occasion sets is directly indicated. For example, the second association is used to directly indicate the association between antenna port sets and random access occasion sets. In some embodiments, the association between antenna port sets and random access occasion sets is indirectly indicated. For example, the second association indirectly indicates the association between antenna port sets and random access occasion sets by indicating the association between antenna port sets and synchronization signals and the association between synchronization signals and random access occasion sets. As an example, antenna port set 0 is associated with SSB 0, and SSB 0 is associated with random access occasion set 0. Therefore, antenna port set 0 is associated with random access occasion set 0. As another example, antenna port set 1 is associated with SSB 1, SSB 1 is associated with random access occasion set 1. Therefore, antenna port set 1 is associated with random access occasion set 1.

In some embodiments, the second association may indicate the association between antenna port sets and random access occasion sets by indicating the identifiers of the antenna port sets and identifiers of the random access occasion sets. For example, the second association may include: antenna port set 0 being associated with random access occasion set 0, antenna port set 1 being associated with random access occasion set 1, etc.

In some embodiments, in the second association, one antenna port set may be associated with one random access occasion set. That is, there may be a one-to-one correspondence between antenna port sets and random access occasion sets. For example, antenna port set 0 is associated with random access occasion set 0, and antenna port set 1 is associated with random access occasion set 1.

In some embodiments, in the second association, one antenna port set can be associated with multiple random access occasion sets. That is, there can be a one-to-many correspondence between antenna port sets and random access occasion sets. For example, antenna port set 0 is associated with both random access occasion set 0 and random access occasion set 1.

In some embodiments, in the second association, multiple antenna port sets can be associated with one random access occasion set. That is, there can be a many-to-one correspondence between antenna port sets and random access occasion sets. For example, both antenna port set 0 and antenna port set 1 are associated with random access occasion set 0.

In some embodiments, the second association may indicate the association between synchronization signals and random access occasion sets by indicating the indexes of the synchronization signals and the identifiers of the random access occasion sets. For example, the second association may include: SSB 0 being associated with random access occasion set 0, SSB 1 being associated with random access occasion set 1, etc.

In some embodiments, in the second association, one synchronization signal may be associated with one random access occasion set, that is, there may be a one-to-one correspondence between synchronization signals and random access occasion sets. For example, SSB 0 is associated with random access occasion set 0, SSB 1 is associated with random access occasion set 1.

In some embodiments, in the second association, one synchronization signal can be associated with multiple random access occasion sets, that is, there can be a one-to-many correspondence between synchronization signals and random access occasion sets. For example, SSB 0 is associated with both random access occasion set 0 and random access occasion set 1.

In some embodiments, in the second association, multiple synchronization signals can be associated with one random access occasion set, that is, there can be a many-to-one correspondence between synchronization signals and random access occasion sets. For example, both SSB 0 and SSB 1 are associated with random access occasion set 0.

In some embodiments, the second association may include one or more of: a correspondence between one antenna port set and one random access occasion set; a correspondence between one antenna port set and multiple random access occasion sets; a correspondence between multiple antenna port sets and one random access occasion set; a one-to-one correspondence between multiple antenna port sets and multiple random access occasion sets; a correspondence between one antenna-port-set identifier and one random-access-occasion-set identifier; a correspondence between one antenna-port-set identifier and multiple random-access-occasion-set identifiers; a correspondence between multiple antenna-port-set identifiers and one random-access-occasion-set identifier; a one-to-one correspondence between multiple antenna-port-set identifiers and multiple random-access-occasion-set identifiers; a correspondence between one synchronization signal and one random access occasion set; a correspondence between one synchronization signal and multiple random access occasion sets; a correspondence between multiple synchronization signals and one random access occasion set; a one-to-one correspondence between multiple synchronization signals and multiple random access occasion sets; a correspondence between one synchronization-signal index and one random-access-occasion-set identifier; a correspondence between one synchronization-signal index and multiple random-access-occasion-set identifiers; a correspondence between multiple synchronization-signal indexes and one random-access-occasion-set identifier; or a one-to-one correspondence between multiple synchronization-signal indexes and multiple random-access-occasion-set identifiers.

In some embodiments, the second association may be predefined or preconfigured. For example, the second association may be predefined in a protocol. In some embodiments, the second association may be configured by the network device through high-layer signaling.

In some embodiments, the terminal device may send the random access signal in the at least one random access occasion in the first random access occasion set, where the at least one random access occasion is determined according to the second association. In other words, the terminal device may determine the at least one random access occasion in the first random access occasion set according to the second association, and send the random access signal in the at least one random access occasion.

In some embodiments, the terminal device may send the random access signal through the at least one antenna port in the first antenna port set. In other words, the at least one antenna port in the first antenna port set may be used to detect the first random access occasion set associated with the first antenna port set. For example, the at least one antenna port in the first antenna port set may be used to monitor whether there is a random access signal on a resource in the first random access occasion set associated with the first antenna port set. Additionally/alternatively, the at least one antenna port in the first antenna port set may be used to receive the random access signal transmitted on the resource in the first random access occasion set associated with the first antenna port set.

In some embodiments, the terminal device may send the random access signal through the at least one antenna port in the first antenna port set, which may include one or more of the following. The terminal device sends the random access signal through the antenna port for sending the first synchronization signal in the first antenna port set. The terminal device sends the random access signal through some antenna ports in the first antenna port set. The terminal device sends the random access signal through all antenna ports in the first antenna port set. The terminal device sends the random access signal through the primary antenna port in the first antenna port set. The terminal device sends the random access signal through the secondary antenna port in the first antenna port set.

In some embodiments, the terminal device sends the random access signal through the antenna port for sending the first synchronization signal in the first antenna port set, which means that the antenna port for sending the first synchronization signal and the antenna port for detecting the random access signal are the same. For example, if the first synchronization signal is transmitted on antenna port 0 in the first antenna port set, then the subsequent detection of the random access signal will also be performed on antenna port 0 in the first antenna port set.

In some embodiments, when the terminal device sends the random access signal through all antenna ports in the first antenna port set, all antenna ports in the first antenna port set may be used to detect the random access signal. As an implementation, the secondary antenna port in the first antenna port set may be used to detect the random access signal and report the detection result to the primary antenna port. The primary antenna port in the first antenna port set may be used to detect the random access signal and perform random access response scheduling according to the detected random access signal.

In some embodiments, when the terminal device sends the random access signal through the primary antenna port in the first antenna port set, one or more primary antenna ports in the first antenna port set may be used to detect the random access signal.

In some embodiments, when the terminal device sends the random access signal through the secondary antenna port in the first antenna port set, one or more secondary antenna ports in the first antenna port set may be used to detect the random access signal.

In some embodiments, the secondary antenna ports in the first antenna port set are not used to detect the random access occasion set associated with the first antenna port set. In other words, the secondary antenna ports in the first antenna port set are not used to detect random access signals.

In some embodiments, the at least one antenna port in the first antenna port set can be used to detect the first random access occasion set associated with the first antenna port set, and the at least one antenna port does not detect the random access occasion set that is not associated with the first antenna port set.

In some embodiments, the terminal device sends the random access signal through the at least one antenna port in the first antenna port set, which may have the following meaning. A TX spatial filter used by the terminal device for sending the random access signal partially overlaps or completely overlaps with a RX spatial filter of the at least one antenna port. For example, the terminal device sends the random access signal through the primary antenna port in the first antenna port set, which may have the following meaning. The TX spatial filter used by the terminal device for sending the random access signal partially overlaps or completely overlaps with a RX spatial filter of the primary antenna port in the first antenna port set.

In some embodiments, the terminal device sends the random access signal through the at least one antenna port in the first antenna port set, which may have the following meaning. The resource on which the terminal device sends the random access signal is associated with the at least one antenna port. For example, the terminal device sends the random access signal through the primary antenna port in the first antenna port set, which may have the following meaning. The resource on which the terminal device sends the random access signal is associated with the primary antenna port in the first antenna port set.

In some embodiments, the terminal device sends the random access signal through the at least one antenna port in the first antenna port set, which may have the following meaning. A transmit beam direction used by the terminal device for sending the random access signal is associated with a receive beam direction of the at least one antenna port. For example, the terminal device sends the random access signal through the primary antenna port in the first antenna port set, which may have the following meaning. The transmit beam direction used by the terminal device for sending the random access signal is associated with a receive beam direction of the primary antenna port in the first antenna port set.

In some embodiments, the terminal device may send the random access signal in the at least one random access occasion in the first random access occasion set as follows. The terminal device sends the random access signal through the at least one antenna port in the first antenna port set in the at least one random access occasion in the first random access occasion set. The at least one antenna port in the first antenna port set may be one or more of: an antenna port for sending the first synchronization signal in the first antenna port set, some antenna ports in the first antenna port set, all antenna ports in the first antenna port set, a primary antenna port in the first antenna port set, or a secondary antenna port in the first antenna port set.

In some embodiments, after sending the random access signal, the terminal device may further detect the random access response, where the random access response is in response to the random access signal sent by the terminal device.

The antenna port for sending the random access response is not limited in the present application. For example, the random access response is sent through the at least one antenna port in the first antenna port set. Exemplarily, the at least one antenna port in the first antenna port set can be one or more of: an antenna port for sending the first synchronization signal in the first antenna port set, some antenna ports in the first antenna port set, all antenna ports in the first antenna port set, a primary antenna port in the first antenna port set, or a secondary antenna port in the first antenna port set.

As an implementation, the primary antenna port in the first antenna port set may be used to send the random access response. As another specific implementation, the primary antenna port in the first antenna port set may schedule the secondary antenna port to send the random access response. For example, the primary antenna port may schedule the secondary antenna port on which the random access signal is detected to send the random access response.

In some embodiments, the at least one antenna port in the first antenna port set may be used to transmit first indication information, and the first indication information may be used to determine the first antenna port set and/or a transmitted synchronization signal. The first indication information is described in detail below.

In some embodiments, the first indication information can be used to determine at least one of the following information: an identifier of the first antenna port set; identifiers of antenna ports included in the first antenna port set; an identifier of a primary antenna port in the first antenna port set; an identifier of a secondary antenna port in the first antenna port set; an identifier of an antenna port for sending the first synchronization signal in the first antenna port set; an identifier of an antenna port for detecting a random access signal in the first antenna port set; an identifier of an antenna port for sending a random access response in the first antenna port set; an index of a synchronization signal transmitted in a communication network in which the first antenna port set is located; an index of a synchronization signal associated with the first antenna port set; an index of a synchronization signal for which rate matching is performed during data transmission through an antenna port in the first antenna port set; a type of a quasi co-location relationship associated with the first antenna port set; or an association between the first antenna port set and a first random access occasion set.

In some embodiments, the first indication information is used to determine the transmitted synchronization signal, which may have the following meaning. The first indication information is used to indicate the synchronization signal associated with the first antenna port set, to determine the synchronization signal transmitted through the first antenna port set. For example, the at least one antenna port in the first antenna port set may be used to send the first indication information, where the first indication information indicates that the transmitted synchronization signal is SSB 0 by indicating that the synchronization signal associated with the first antenna port set is SSB 0.

In some embodiments, the first indication information is used to determine the transmitted synchronization signal, which may have the following meaning. The first indication information is used to indicate the synchronization signal transmitted in the communication network in which the first antenna port set is located. For example, the communication network in which the first antenna port set is located includes the first antenna port set and a second antenna port set, the first antenna port set is associated with SSB 0, and the second antenna port set is associated with SSB 1. The at least one antenna port in the first antenna port set may be used to send the first indication information, where the first indication information indicates that the transmitted synchronization signals are SSB 0 and SSB 1.

The at least one antenna port for transmitting the first indication information is not limited in the embodiments of the present application. For example, the at least one antenna port for sending the first indication information may be one or more of: an antenna port for sending the first synchronization signal in the first antenna port set, an antenna port for detecting the random access signal in the first antenna port set, or all antenna ports in the first antenna port set.

In some embodiments, when data transmission scheduling is performed through the antenna port in the first antenna port set, perform rate matching around the resource used for synchronization signal transmission.

As an implementation, when data transmission scheduling is performed through the antenna port in the first antenna port set, perform rate matching around the resource for synchronization signal transmission associated with the first antenna port set. For example, the first antenna port set is associated with SSB 0, a first time-frequency resource is scheduled through the antenna port in the first antenna port set, for data transmission, and transmission of SSB 0 occupies a second time-frequency resource. If the first time-frequency resource and the second time-frequency resource at least partially overlap in the time domain and/or frequency domain, the overlapping portion is not used for data transmission.

As another implementation, when data transmission scheduling is performed through the antenna port in the first antenna port set, perform rate matching around the resource of the synchronization signal transmitted in the communication network in which the first antenna port set is located. For example, the SSBs transmitted in the communication network in which the first antenna port set is located include SSB 0 and SSB 1, the first time-frequency resource is scheduled through the antenna port in the first antenna port set, for data transmission, and transmission of SSB 0 and SSB 1 occupies a third time-frequency resource. If the first time-frequency resource and the third time-frequency resource at least partially overlap in the time domain and/or frequency domain, the overlapping portion is not used for data transmission.

For ease of understanding, in the following, as an example, the synchronization signal is the SSB in the NR system and the random access occasion set is the RO set in the NR system, and the initial access procedure in Embodiment 1 is described in combination with the network architecture illustrated in FIG. 9.

The communication network includes a first AP set (such as AP set 0 in FIG. 9) and a second AP set (such as AP set 1 in FIG. 9). The APs in the first AP set are used to transmit SSB 0, and the APs in the first AP set are not used to transmit SSB 1; the APs in the second AP set transmit SSB 1, and the APs in the second AP set are not used to transmit SSB 0. Optionally, the positions of SSB 0 and SSB 1 in the radio frame are the same as the positions of SSB 0 and SSB 1 in the radio frame in the NR system. Optionally, the identifier of the AP set is determined according to the SSB index, that is, the identifier of the first AP set associated with SSB 0 is 0, and the identifier of the second AP set associated with SSB 1 is 1.

The first AP set is associated with a first RO set, and the second AP set is associated with a second RO set.

In the initial access procedure, the terminal device attempts to search for an SSB by using the predefined possible time-frequency positions of the SSB. In the scenario illustrated in FIG. 9, the terminal device may detect SSB 1 and, through the detected SSB 1, obtain time and frequency synchronization, radio frame timing and determine the identifier of the second AP set. Accordingly, the terminal device can initiate random access to the network device through an RO in the second RO set.

Alternatively, the terminal device may also detect SSB 0 and SSB 1, and, through the detected SSB 0 and SSB 1, obtain time and frequency synchronization, radio frame timing and determine the identifier of the first AP set and the identifier of the second AP set. Accordingly, the terminal device may initiate random access to the network device through an RO in the first RO set. Alternatively, the terminal device may initiate random access to the network device through an RO in the second RO set. Alternatively, the terminal device may select an AP set associated with an SSB with a stronger signal, such as the second AP set, according to the received signal strengths of SSB 0 and SSB 1, and initiate random access to the network device through an RO in the second RO set associated with the second AP set.

In some cases, the primary AP in the first AP set is used to transmit SSB 0, while the secondary AP is not used to transmit SSB 0; the primary AP in the second AP set is used to transmit SSB 1, while the secondary AP is not used to transmit SSB 1. Accordingly, the primary AP in the first AP set is used to detect ROs in the first RO set, while the secondary AP is not used to detect ROs in the first RO set; the primary AP in the second AP set is used to detect ROs in the second RO set, while the secondary AP is not used to detect ROs in the second RO set.

In other cases, all APs in the first AP set are used to transmit SSB 0, and all APs in the second AP set are used to transmit SSB 1. Accordingly, all APs in the first AP set are used to detect ROs in the first RO set, and all APs in the second AP set are used to detect ROs in the second RO set.

In the 4-step random access procedure, initiating random access by the terminal device includes sending a random access preamble.

When the random access preamble transmitted on the RO is detected through the primary AP in the AP set, the network device schedules the primary AP to send the RAR corresponding to the random access preamble to the terminal device. After receiving the RAR, the terminal device sends message 3 through the primary AP. After receiving message 3, the network device schedules the primary AP to send message 4 to the terminal device, thereby completing random access. Optionally, the embodiment is applicable to the case where the primary AP in the AP set is used to transmit the SSB associated with the AP set.

Alternatively, when the random access preamble transmitted on the RO is detected through the secondary AP in the AP set, the detection result is reported to the network device through the secondary AP, and the network device then schedules the primary AP in the AP set to send the RAR corresponding to the random access preamble to the terminal device. After receiving the RAR, the terminal device sends message 3 through the primary AP. After receiving message 3, the network device schedules the primary AP to send message 4 to the terminal device, thereby completing random access. Optionally, the embodiment is applicable to the case where the primary AP in the AP set is used to transmit the SSB associated with the AP set and the secondary AP is not used to transmit the SSB associated with the AP set.

Alternatively, when the random access preamble transmitted on the RO is detected through the secondary AP in the AP set, the network device schedules the secondary AP to send the RAR corresponding to the random access preamble to the terminal device. After receiving the RAR, the terminal device sends message 3 through the secondary AP. After receiving message 3, the network device schedules the secondary AP to send message 4 to the terminal device, thereby completing random access. Optionally, the embodiment is applicable to the case where the secondary AP in the AP set is used to transmit the SSB associated with the AP set.

In the 2-step random access procedure, initiating random access by the terminal device includes sending the random access preamble and uplink information.

When the random access preamble and uplink information transmitted on the RO are detected through the primary AP in the AP set, the network device schedules the primary AP to send the RAR corresponding to the successful random access to the terminal device, thereby completing random access. When, through the primary AP in the AP set, the random access preamble transmitted on the RO is detected but the uplink information is not detected, the network device schedules the primary AP to send the RAR corresponding to the random access preamble to the terminal device, and falls back to the 4-step random access procedure. Optionally, the embodiment is applicable to the case where the primary AP in the AP set is used to transmit the SSB associated with the AP set.

Alternatively, when the random access preamble and uplink information transmitted on the RO are detected through the secondary AP in the AP set, the detection result is reported to the network device through the secondary AP, and the network device schedules the primary AP in the AP set to send the RAR corresponding to the successful random access to the terminal device, thereby completing random access. When, through the secondary AP in the AP set, the random access preamble transmitted on the RO is detected but the uplink information is not detected, the network device schedules the primary AP in the AP set to send the RAR corresponding to the random access preamble to the terminal device, and falls back to the 4-step random access procedure. Optionally, the embodiment is applicable to the case where the primary AP in the AP set is used to transmit the SSB associated with the AP set and the secondary AP is not used to transmit the SSB associated with the AP set.

Alternatively, when the random access preamble and uplink information transmitted on the RO are detected through the secondary AP in the AP set, the network device schedules the secondary AP to send the RAR corresponding to the successful random access to the terminal device, thereby completing random access. When, through the secondary AP in the AP set, the random access preamble transmitted on the RO is detected but the uplink information is not detected, the network device schedules the secondary AP to send the RAR corresponding to the random access preamble to the terminal device, and falls back to the 4-step random access procedure. Optionally, the embodiment is applicable to the case where the secondary AP in the AP set is used to transmit the SSB associated with the AP set.

### Embodiment 2: Synchronization Signal Associated with Antenna Port

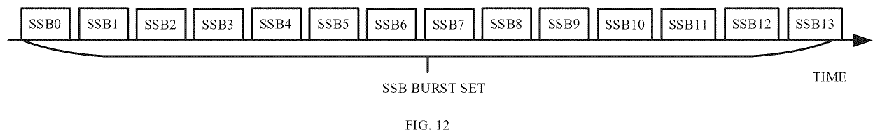

To enable a terminal device to access a wireless communication network based on a distributed antenna system, a network device can send a synchronization signal through an antenna port in the communication network. Taking the communication network illustrated in FIG. 10 as an example, the network device can send a synchronization signal through one or more antenna ports among antenna port 0 to antenna port 13, as illustrated in FIG. 12.

It should be understood that the synchronization signal sent by the network device may refer to an SSB or other forms of synchronization signal. In some embodiments, the synchronization signal sent by the network device may be the same as or different from the synchronization signal in the existing system, and the present application is not limited to this.

After the network device sends the synchronization signal, the terminal device can detect the synchronization signal sent by the network device. The synchronization signal sent by the network device can include a first synchronization signal, and the first synchronization signal can be, for example, any one or more synchronization signals among the synchronization signals sent by the network device.

In some embodiments, the first synchronization signal may be, for example, a synchronization signal with the strongest received signal strength detected by the terminal device.

In some embodiments, the first synchronization signal may be, for example, a synchronization signal whose received signal strength detected by the terminal device exceeds a second threshold. It should be noted that the second threshold is not limited in embodiments of the present application. The second threshold may be a value that is set according to actual conditions. For example, the second threshold is −50 dBm. It should also be noted that the embodiment of the present application does not limit the configuration method of the second threshold. For example, the second threshold may be predefined or preconfigured, or may be configured by the network device through high-layer signaling (such as RRC signaling), or may be determined based on the implementation of the terminal device.

In some embodiments, the second threshold and the first threshold mentioned above may be the same. For example, the second threshold and the first threshold may both be −50 dBm.

In some embodiments, the second threshold and the first threshold mentioned above may be different. For example, the second threshold is set to −50 dBm, and the first threshold is set to −55 dBm.

In some embodiments, after the terminal device detects the first synchronization signal, at least one antenna port associated with the first synchronization signal can be determined according to the first synchronization signal.

In some embodiments, the at least one antenna port associated with the first synchronization signal is a second antenna port, where the first synchronization signal is associated with the second antenna port.

The second antenna port can be any antenna port in the wireless communication network system. Taking the network system illustrated in FIG. 10 as an example, the second antenna port can be antenna port 0 in FIG. 10, or antenna port 2 in FIG. 10, or antenna port 12 in FIG. 10, etc.

In some embodiments, the first synchronization signal being associated with the second antenna port may mean that there is an association or mapping relationship between the first synchronization signal and the second antenna port, and the second antenna port can be determined according to the first synchronization signal or the first synchronization signal can be determined according to the second antenna port.

In some embodiments, the association between the first synchronization signal and the second antenna port is indicated by a third association. In other words, the third association can be used to indicate the association between synchronization signals and antenna ports, such as indicating antenna ports associated with different synchronization signals.

That is, in the embodiment of the present application, different antenna ports can be associated with different synchronization signals. The association between different antenna ports and different synchronization signals can be indicated by the third association. The third association is introduced below.

In some embodiments, the third association may indicate the association between synchronization signals and antenna ports by indicating indexes of the synchronization signals and identifiers of the antenna ports. For example, the third association may include: SSB 0 being associated with antenna port 0, SSB 1 being associated with antenna port 1, etc.

In some embodiments, in the third association, one synchronization signal can be associated with one antenna port, that is, there can be a one-to-one correspondence between synchronization signals and antenna ports. For example, SSB 0 is associated with antenna port 0, and SSB 1 is associated with antenna port 1.

In some embodiments, in the third association, one synchronization signal can be associated with multiple antenna ports, that is, there can be a one-to-many correspondence between synchronization signals and antenna ports. For example, SSB 0 is associated with both antenna port 0 and antenna port 1.

In some embodiments, in the third association, multiple synchronization signals can be associated with one antenna port, that is, there can be a many-to-one correspondence between synchronization signals and antenna ports. For example, both SSB 0 and SSB 1 are associated with antenna port 0.

In some embodiments, the third association may include one or more of: a correspondence between one synchronization signal and one antenna port; a correspondence between one synchronization signal and antenna ports; a correspondence between synchronization signals and one antenna port; a one-to-one correspondence between synchronization signals and antenna ports; a correspondence between one synchronization-signal index and one antenna port identifier; a correspondence between one synchronization-signal index and antenna port identifiers; a correspondence between synchronization-signal indexes and one antenna port identifier; or a one-to-one correspondence between synchronization-signal indexes and antenna port identifiers.

In some embodiments, the third association may be predefined or preconfigured. For example, the third association may be predefined in a protocol. In some embodiments, the third association may be configured by the network device through high-layer signaling.

In some embodiments, the terminal device determines, according to the first synchronization signal, the at least one antenna port associated with the first synchronization signal as follows. The terminal device determines an identifier of the second antenna port according to the first synchronization signal. For example, the terminal device determines the identifier of the second antenna port associated with the first synchronization signal according to the first synchronization signal and the third association.

That is, in some embodiments, the identifier of the second antenna port is determined according to the first synchronization signal. The implementation of determining the identifier of the second antenna port according to the first synchronization signal is not limited in the embodiments of the present application. For example, the identifier of the second antenna port can be determined explicitly or implicitly through the first synchronization signal.

As an implementation, the identifier of the second antenna port can be determined according to one or more of: an index of the first synchronization signal, a synchronization signal sequence corresponding to the first synchronization signal, or information transmitted in a downlink channel associated with the first synchronization signal. For a detailed description of how to determine the identifier of the second antenna port by using the above information, reference is made to the previous article. For the sake of brevity, will not be repeated here.

As mentioned above, the first synchronization signal is sent by the network device to the terminal device. The sending of the first synchronization signal is introduced below.

In some embodiments, the first synchronization signal may be sent according to the third association. In this case, the terminal device may determine the at least one antenna port associated with the first synchronization signal according to the first synchronization signal as follows. The terminal device determines the second antenna port according to the first synchronization signal and the third association.

In some embodiments, the second antenna port is not used to send the synchronization signal that is not associated with the second antenna port. For example, if the first synchronization signal has a one-to-one correspondence with the second antenna port, the second antenna port is not used to send synchronization signals other than the first synchronization signal.

In some embodiments, a fourth association is established between the second antenna port and the second random access occasion set, and/or the fourth association is established between the first synchronization signal and the second random access occasion set. At least one random access occasion in the second random access occasion set is used to transmit a random access signal (e.g., preamble).

That is, in the embodiment of the present application, different antenna ports can be associated with different random access occasion sets. The association between different antenna ports and different random access occasion sets can be indicated by the fourth association. Alternatively, in the embodiment of the present application, different synchronization signals can be associated with different random access occasion sets. The association between different synchronization signals and different random access occasion sets can be indicated by the fourth association. The fourth association is described below.

In some embodiments, the association between antenna ports and random access occasion sets is directly indicated. For example, the fourth association is used to directly indicate the association between antenna ports and random access occasion sets. In some embodiments, the association between antenna ports and random access occasion sets is indirectly indicated. For example, the fourth association indirectly indicates the association between antenna ports and random access occasion sets by indicating the association between antenna ports and synchronization signals and the association between synchronization signals and random access occasion sets. As an example, antenna port 0 is associated with SSB 0, and SSB 0 is associated with random access occasion set 0. Therefore, antenna port 0 is associated with random access occasion set 0. As another example, antenna port 1 is associated with SSB 1, and SSB 1 is associated with random access occasion set 1. Therefore, antenna port 1 is associated with random access occasion set 1.

In some embodiments, the fourth association may indicate the association between antenna ports and random access occasion sets by indicating the identifiers of the antenna ports and identifiers of the random access occasion sets. For example, the fourth association may include: antenna port 0 being associated with random access occasion set 0, antenna port 1 being associated with random access occasion set 1, etc.

In some embodiments, in the fourth association, one antenna port may be associated with one random access occasion set. That is, there may be a one-to-one correspondence between antenna ports and random access occasion sets. For example, antenna port 0 may be associated with random access occasion set 0, and antenna port 1 may be associated with random access occasion set 1.

In some embodiments, in the fourth association, one antenna port can be associated with multiple random access occasion sets. That is, there can be a one-to-many correspondence between antenna ports and random access occasion sets. For example, antenna port 0 is associated with both random access occasion set 0 and random access occasion set 1.

In some embodiments, in the fourth association, multiple antenna ports can be associated with one random access occasion set, that is, there can be a many-to-one correspondence between antenna ports and random access occasion sets. For example, both antenna port 0 and antenna port 1 are associated with random access occasion set 0.

In some embodiments, the fourth association may indicate the association between synchronization signals and random access occasion sets by indicating the indexes of the synchronization signals and the identifiers of the random access occasion sets. For example, the fourth association may include: SSB 0 being associated with random access occasion set 0, SSB 1 being associated with random access occasion set 1, etc.

In some embodiments, in the fourth association, one synchronization signal may be associated with one random access occasion set, that is, there may be a one-to-one correspondence between synchronization signals and random access occasion sets. For example, SSB 0 is associated with random access occasion set 0, SSB 1 is associated with random access occasion set 1.

In some embodiments, in the fourth association, one synchronization signal can be associated with multiple random access occasion sets, that is, there can be a one-to-many correspondence between synchronization signals and random access occasion sets. For example, SSB 0 is associated with both random access occasion set 0 and random access occasion set 1.

In some embodiments, in the fourth association, multiple synchronization signals can be associated with one random access occasion set, that is, there can be a many-to-one correspondence between synchronization signals and random access occasion sets. For example, both SSB 0 and SSB 1 are associated with random access occasion set 0.

In some embodiments, the fourth association may include one or more of: a correspondence between one antenna port and one random access occasion set; a correspondence between one antenna port and multiple random access occasion sets; a correspondence between multiple antenna ports and one random access occasion set; a one-to-one correspondence between multiple antenna ports and multiple random access occasion sets; a correspondence between one antenna port identifier and one random-access-occasion-set identifier; a correspondence between one antenna port identifier and multiple random-access-occasion-set identifiers; a correspondence between multiple antenna port identifiers and one random-access-occasion-set identifier; a one-to-one correspondence between multiple antenna port identifiers and multiple random-access-occasion-set identifiers; a correspondence between one synchronization signal and one random access occasion set; a correspondence between one synchronization signal and multiple random access occasion sets; a correspondence between multiple synchronization signals and one random access occasion set; a one-to-one correspondence between multiple synchronization signals and multiple random access occasion sets; a correspondence between one synchronization-signal index and one random-access-occasion-set identifier; a correspondence between one synchronization-signal index and multiple random-access-occasion-set identifiers; a correspondence between multiple synchronization-signal indexes and one random-access-occasion-set identifier; or a one-to-one correspondence between multiple synchronization-signal indexes and multiple random-access-occasion-set identifiers.

In some embodiments, the fourth association may be predefined or preconfigured. For example, the fourth association may be predefined in a protocol. In some embodiments, the fourth association may be configured by the network device through high-layer signaling.

In some embodiments, the terminal device may send the random access signal in the at least one random access occasion in the second random access occasion set, where the at least one random access occasion is determined according to the fourth association. In other words, the terminal device may determine the at least one random access occasion in the second random access occasion set according to the fourth association, and send the random access signal in the at least one random access occasion.

In some embodiments, the terminal device may send the random access signal through the second antenna port. In other words, the second antenna port may be used to detect the second random access occasion set associated with the second antenna port. For example, the second antenna port may be used to monitor whether there is a random access signal on a resource in the second random access occasion set associated with the second antenna port. Additionally/alternatively, the second antenna port may be used to receive the random access signal transmitted on the resource in the second random access occasion set associated with the second antenna port.

In some embodiments, the second antenna port may be used to detect the second random access occasion set associated with the second antenna port, and the second antenna port is not used to detect the random access occasion set not associated with the second antenna port.

In some embodiments, the terminal device sends the random access signal through the second antenna port, which may have the following meaning. A TX spatial filter used by the terminal device for sending the random access signal partially or completely overlaps with a RX spatial filter of the second antenna port.

In some embodiments, the terminal device sends the random access signal through the second antenna port, which may have the following meaning. A resource on which the terminal device sends the random access signal is associated with the second antenna port.

In some embodiments, the terminal device sends the random access signal through the second antenna port, which may have the following meaning. A transmit beam direction used by the terminal device for sending the random access signal is associated with a receive beam direction of the second antenna port.

In some embodiments, the terminal device may send the random access signal in the at least one random access occasion in the second random access occasion set as follows. The terminal device sends the random access signal through the second antenna port in the at least one random access occasion in the second random access occasion set.

In some embodiments, after sending the random access signal, the terminal device may further detect the random access response, where the random access response is in response to the random access signal sent by the terminal device.

The antenna port for sending the random access response is not limited in the present application. For example, the random access response is sent through the second antenna port.

In some embodiments, the second antenna port can be used to transmit second indication information, and the second indication information can be used to determine the second antenna port and/or a transmitted synchronization signal. The second indication information is described in detail below.

In some embodiments, the second indication information can be used to determine at least one of the following information: an identifier of the second antenna port; an index of a synchronization signal transmitted in a communication network in which the second antenna port is located; an index of a synchronization signal associated with the second antenna port; an index of a synchronization signal for which rate matching is performed during data transmission through the second antenna port; a type of a quasi co-location relationship associated with the second antenna port; or an association between the second antenna port and a second random access occasion set.

In some embodiments, the second indication information is used to determine the transmitted synchronization signal, which may have the following meaning. The second indication information is used to indicate the synchronization signal associated with the second antenna port, to determine the synchronization signal transmitted through the second antenna port. For example, the second antenna port may be used to send the second indication information, where the second indication information indicates that the transmitted synchronization signal is SSB 0 by indicating that the synchronization signal associated with the second antenna port is SSB 0.

In some embodiments, the second indication information is used to determine the transmitted synchronization signal, which may have the following meaning. The second indication information is used to indicate the synchronization signal transmitted in the communication network in which the second antenna port is located. For example, the communication network in which the second antenna port is located includes a first antenna port and the second antenna port, the first antenna port is associated with SSB 0, and the second antenna port is associated with SSB 1. The second antenna port may be used to send the second indication information, where the second indication information indicates that the transmitted synchronization signals are SSB 0 and SSB 1.

In some embodiments, when data transmission scheduling is performed through the second antenna port, perform rate matching around the resource used for synchronization signal transmission.

As an implementation, when data transmission scheduling is performed through the second antenna port, perform rate matching around the resource for synchronization signal transmission associated with the second antenna port. For example, the second antenna port is associated with SSB 0, a first time-frequency resource is scheduled through the second antenna port, for data transmission, and transmission of SSB 0 occupies a second time-frequency resource. If the first time-frequency resource and the second time-frequency resource at least partially overlap in the time domain and/or frequency domain, the overlapping portion is not used for data transmission.

As another implementation, when data transmission scheduling is performed through the second antenna port, perform rate matching around the resource of the synchronization signal transmitted in the communication network in which the second antenna port is located. For example, the SSBs transmitted in the communication network in which the second antenna port is located include SSB 0 and SSB 1, the first time-frequency resource is scheduled through the second antenna port, for data transmission, and transmission of SSB 0 and SSB 1 occupies a third time-frequency resource. If the first time-frequency resource and the third time-frequency resource at least partially overlap in the time domain and/or frequency domain, the overlapping portion is not used for data transmission.

In some embodiments, the terminal device may send (report) the selected synchronization signal and/or antenna port to the network device. In other words, the terminal device may send (report) the detected synchronization signal and/or antenna port to the network device.

As an implementation, the terminal device can send third indication information to the network device, where the third indication information is used to determine M antenna ports selected by the terminal device and/or N synchronization signals selected by the terminal device, where N and M are positive integers.

In some embodiments, the third indication information is used to determine the M antenna ports selected by the terminal device, which has the following meaning. The third indication information is used to indicate identifiers of the M antenna ports selected by the terminal device, where M is predefined or preconfigured, or M is determined according to a third threshold value and the third threshold value is predefined or preconfigured.

In some embodiments, the M antenna ports selected by the terminal device can be M antenna ports corresponding to signal strengths ranking from strong to weak. That is, the M antenna ports selected by the terminal device can be M antenna ports with the strongest signal strengths among the multiple antenna ports associated with the terminal device.

In some embodiments, the M antenna ports selected by the terminal device may be M antenna ports that are greater than or equal to a third threshold value. In other words, M is determined according to the third threshold value.

In some embodiments, the third threshold value may be a value indicating a signal strength. For example, the threshold value may be a signal strength greater than −50 dBm.

In some embodiments, if the number of antenna ports determined by the terminal device is less than M, the indication bit may be a preset value or a padding value.

In some embodiments, the third indication information is used to determine the N synchronization signals selected by the terminal device, which has the following meaning. The third indication information is used to indicate indexes of the N synchronization signals selected by the terminal device, where N is predefined or preconfigured, or N is determined according to a fourth threshold value and the fourth threshold value is predefined or preconfigured.

In some embodiments, the N synchronization signals selected by the terminal device may be N synchronization signals with received signal strengths ranking from strong to weak. That is, the N synchronization signals selected by the terminal device may be N synchronization signals with the strongest signal strengths detected by the terminal device.

In some embodiments, the N synchronization signals selected by the terminal device may be N synchronization signals that are greater than or equal to a fourth threshold value. In other words, N is determined according to the fourth threshold value.

In some embodiments, the fourth threshold value may be a value indicating a received signal strength. For example, the threshold value may be a received signal strength greater than −50 dBm.

In some embodiments, if the number of synchronization signals determined by the terminal device is less than N, the indication bit may be a preset value or a padding value.

The manner of carrying the third indication information is not limited in embodiments of the present application. Exemplarily, the third indication information can be carried in one or more of the following transmissions: a random access signal, an uplink transmission of random access response scheduling, or an uplink transmission after the random access procedure is completed.

As an example, the third indication information may be carried in a preamble. As another example, the third indication information may be carried in Msg 3. As yet another example, the third indication information may be carried in Msg 5 after the random access procedure is completed. As yet another example, the third indication information may be carried in uplink scheduling after the random access procedure is completed. As yet another example, the third indication information may be carried in uplink information in the 2-step random access procedure, etc.

For ease of understanding, in the following, as an example, the synchronization signal is the SSB in the NR system and the random access occasion set is the RO set in the NR system, and the initial access procedure in Embodiment 2 is described in combination with the network system architecture illustrated in FIG. 10.

As illustrated in FIG. 10, the communication network includes 14 APs, and the 14 APs are used to transmit SSB 0 to SSB 13 respectively. Each AP is only used to transmit the SSB associated with the AP, for example, the first AP is only used to transmit SSB 0, the second AP is only used to transmit SSB 1, and so on. Optionally, the positions of SSB 0 to SSB 13 in the radio frame are the same as the positions of SSB 0 to SSB 13 in the radio frame in the NR system. Optionally, the identifier of the AP is determined according to the SSB index, for example, the first AP associated with SSB 0 has an identifier of 0, and the second AP associated with SSB 1 has an identifier of 1.

The first AP is associated with a first RO set, the second AP is associated with a second RO set, and so on.

In the initial access procedure, the terminal device attempts to search for SSBs by using predefined possible time-frequency positions of SSBs. In the scenario illustrated in FIG. 10, the terminal device may detect SSB 6, SSB 7, SSB 11, and SSB 12, and, through at least one of the detected SSBs, obtain time and frequency synchronization, radio frame timing and determine identifiers of the corresponding APs (i.e., AP 6, AP 7, AP 11, and AP 12). Accordingly, the terminal device may initiate random access to the network device through an RO from at least one RO set associated with the APs. For example, based on the signal strength, the terminal device may select the twelfth RO set associated with AP 12 to initiate random access to the network device. Alternatively, the terminal device may select multiple RO sets associated with multiple APs based on a signal strength threshold to respectively initiate random access to the network device. For example, based on the signal strength threshold, the terminal device may select the twelfth RO set associated with AP 12 and the seventh RO set associated with AP 7 to respectively initiate random access to the network device.

In the following, in an example, the terminal device selects the twelfth RO set associated with AP 12 to initiate random access to the network device.

In the 4-step random access procedure, initiating random access by the terminal device includes sending a random access preamble.

When the random access preamble transmitted on the RO is detected through AP 12, the network device schedules AP 12 to send the RAR corresponding to the random access preamble to the terminal device. After receiving the RAR, the terminal device sends message 3 through the primary AP. After receiving message 3, the network device schedules AP 12 to send message 4 to the terminal device, thereby completing random access. Optionally, the terminal device reports the identifier of the AP that can be used for communication of the terminal device to the network device by using at least one of the following information: the random access preamble, message 3, message 5 after the random access procedure is completed, and uplink scheduling after the random access procedure is completed.

In the 2-step random access procedure, initiating random access by the terminal device includes sending a random access preamble and uplink information.

When the random access preamble and uplink information transmitted on the RO are detected through AP 12, the network device schedules AP 12 to send the RAR corresponding to the successful random access to the terminal device, thereby completing random access. When, through AP 12, the random access preamble transmitted on the RO is detected but the uplink information is not detected, the network device schedules AP 12 to send the RAR corresponding to the random access preamble to the terminal device, and falls back to the 4-step random access procedure. Optionally, the terminal device reports the identifier of the AP that can be used for communication of the terminal device to the network device by using at least one of the following information: random access preamble, uplink information, message 3, message 5 after the random access procedure is completed, and uplink scheduling after the random access procedure is completed.

Optionally, the terminal device may report AP 6, AP 7, AP 11 and AP 12. Alternatively, the terminal device may report the optimal M APs according to signal strength, where M is a positive integer and is predefined or configured by the network device.

In embodiments of the present application, a wireless communication method is provided. The method includes the following. A terminal device detects a synchronization signal sent by a network device. The terminal device determines at least one antenna port associated with a first synchronization signal according to the first synchronization signal, after the terminal device detects the first synchronization signal.

In some implementations, the at least one antenna port is an antenna port in a first antenna port set and the first synchronization signal is associated with the first antenna port set.

In some implementations, the first synchronization signal is sent according to a first association, and determining, by the terminal device, the at least one antenna port associated with the first synchronization signal according to the first synchronization signal includes: determining, by the terminal device, the first antenna port set according to the first synchronization signal and the first association.

In some implementations, the first association includes at least one of a correspondence between one synchronization signal and one antenna port set; a correspondence between one synchronization signal and antenna port sets; a correspondence between synchronization signals and one antenna port set; a one-to-one correspondence between synchronization signals and antenna port sets; a correspondence between one synchronization-signal index and one antenna-port-set identifier; a correspondence between one synchronization-signal index and antenna-port-set identifiers; a correspondence between synchronization-signal indexes and one antenna-port-set identifier; or a one-to-one correspondence between synchronization-signal indexes and antenna-port-set identifiers.

In some implementations, determining, by the terminal device, the at least one antenna port associated with the first synchronization signal according to the first synchronization signal includes: determining, by the terminal device, an identifier of the first antenna port set according to the first synchronization signal; or determining, by the terminal device, an identifier of the at least one antenna port in the first antenna port set according to the first synchronization signal.

In some implementations, the identifier of the first antenna port set or the identifier of the at least one antenna port in the first antenna port set is determined according to one or more of the following information: an index of the first synchronization signal; a synchronization signal sequence corresponding to the first synchronization signal; or information transmitted over a downlink channel associated with the first synchronization signal.

In some implementations, the first synchronization signal is sent through some antenna ports in the first antenna port set; or the first synchronization signal is sent through all antenna ports in the first antenna port set; or the first antenna port set includes a primary antenna port, and the first synchronization signal is sent through the primary antenna port.

In some implementations, a synchronization signal that is not associated with the first antenna port set is not sent through some antenna ports in the first antenna port set; or a synchronization signal that is not associated with the first antenna port set is not sent through all antenna ports in the first antenna port set; or the first antenna port set includes a primary antenna port, and a synchronization signal that is not associated with the first antenna port set is not sent through the primary antenna port; or the first antenna port set includes a secondary antenna port, and a synchronization signal that is not associated with the first antenna port set is not sent through the secondary antenna port.

In some implementations, the first antenna port set and a first random access occasion set have a second association, and/or the first synchronization signal and the first random access occasion set have the second association, and the method further includes: determining, by the terminal device, at least one random access occasion in the first random access occasion set according to the second association; and sending, by the terminal device, a random access signal in the at least one random access occasion.

In some implementations, the first synchronization signal includes a synchronization signal with a strongest received signal strength detected by the terminal device or a synchronization signal with a received signal strength exceeding a first threshold detected by the terminal device.

In some implementations, the second association is predefined or preconfigured.

In some implementations, sending, by the terminal device, the random access signal in the at least one random access occasion includes at least one of: sending, by the terminal device, the random access signal through an antenna port for sending the first synchronization signal in the first antenna port set; or sending, by the terminal device, the random access signal through some antenna ports in the first antenna port set; or sending, by the terminal device, the random access signal through all antenna ports in the first antenna port set; or sending, by the terminal device, the random access signal through a primary antenna port in the first antenna port set; or sending, by the terminal device, the random access signal through a secondary antenna port in the first antenna port set.

In some implementations, the method further includes: detecting, by the terminal device, a random access response sent through the at least one antenna port in the first antenna port set; or the first antenna port set includes a primary antenna port and detecting, by the terminal device, a random access response sent through the primary antenna port, where the random access response is in response to the random access signal sent by the terminal device.

In some implementations, the at least one antenna port in the first antenna port set is used to transmit first indication information, and the first indication information is used to determine at least one of the following information: an identifier of the first antenna port set; identifiers of antenna ports included in the first antenna port set; an identifier of a primary antenna port in the first antenna port set; an identifier of a secondary antenna port in the first antenna port set; an identifier of an antenna port for sending the first synchronization signal in the first antenna port set; an identifier of an antenna port for detecting a random access signal in the first antenna port set; an identifier of an antenna port for sending a random access response in the first antenna port set; an index of a synchronization signal transmitted in a communication network in which the first antenna port set is located; an index of a synchronization signal associated with the first antenna port set; an index of a synchronization signal for which rate matching is performed during data transmission through an antenna port in the first antenna port set; a type of a quasi co-location relationship associated with the first antenna port set; or an association between the first antenna port set and a first random access occasion set.

In some implementations, the first indication information is transmitted through the antenna port for sending the first synchronization signal in the first antenna port set; or the first indication information is transmitted through the antenna port for detecting the random access signal in the first antenna port set; or the first indication information is transmitted through all antenna ports in the first antenna port set.

In some implementations, when the first antenna port set includes two or more antenna ports, at least two antenna ports in the first antenna port set are distributed antenna ports or any two antenna ports in the first antenna port set are distributed antenna ports.

In some implementations, the at least one antenna port includes a second antenna port, and the first synchronization signal is associated with the second antenna port.

In some implementations, the first synchronization signal is sent according to a third association, and determining, by the terminal device, the at least one antenna port associated with the first synchronization signal according to the first synchronization signal includes: determining, by the terminal device, the second antenna port according to the first synchronization signal and the third association.

In some implementations, the third association includes at least one of a correspondence between one synchronization signal and one antenna port; a correspondence between one synchronization signal and antenna ports; a correspondence between synchronization signals and one antenna port; a one-to-one correspondence between synchronization signals and antenna ports; a correspondence between one synchronization-signal index and one antenna port identifier; a correspondence between one synchronization-signal index and antenna port identifiers; a correspondence between synchronization-signal indexes and one antenna port identifier; or a one-to-one correspondence between synchronization-signal indexes and antenna port identifiers.

In some implementations, determining, by the terminal device, the at least one antenna port associated with the first synchronization signal according to the first synchronization signal includes: determining, by the terminal device, an identifier of the second antenna port according to the first synchronization signal.

In some implementations, the identifier of the second antenna port is determined according to one or more of the following information: an index of the first synchronization signal; a synchronization signal sequence corresponding to the first synchronization signal; or information transmitted over a downlink channel associated with the first synchronization signal.

In some implementations, the first synchronization signal is sent through the second antenna port; and/or a synchronization signal that is not associated with the second antenna port is not sent through the second antenna port.

In some implementations, the second antenna port and a second random access occasion set have a fourth association, and/or the first synchronization signal and the second random access occasion set have the fourth association, and the method further includes: determining, by the terminal device, at least one random access occasion in the second random access occasion set according to the fourth association, and sending, by the terminal device, a random access signal in the at least one random access occasion; and/or detecting, by the terminal device, a random access response sent through the second antenna port, where the random access response is in response to the random access signal sent by the terminal device.

In some implementations, sending, by the terminal device, the random access signal in the at least one random access occasion includes: sending, by the terminal device, the random access signal through the second antenna port in the at least one random access occasion.

In some implementations, the first synchronization signal includes a synchronization signal with a strongest received signal strength detected by the terminal device or a synchronization signal with a received signal strength exceeding a second threshold detected by the terminal device.

In some implementations, the fourth association is predefined or preconfigured.

In some implementations, the second antenna port is used to transmit second indication information, and the second indication information is used to determine at least one of the following information: an identifier of the second antenna port; an index of a synchronization signal transmitted in a communication network in which the second antenna port is located; an index of a synchronization signal associated with the second antenna port; an index of a synchronization signal for which rate matching is performed during data transmission through the second antenna port; a type of a quasi co-location relationship associated with the second antenna port; or an association between the second antenna port and a second random access occasion set.

In some implementations, the method further includes: sending, by the terminal device, third indication information to the network device, where the third indication information is used to determine M antenna ports selected by the terminal device and/or N synchronization signals selected by the terminal device, and N and M are positive integers.

In some implementations, the third indication information being used to determine the M antenna ports selected by the terminal device includes: the third indication information being used to indicate identifiers of the M antenna ports selected by the terminal device, where M is predefined or preconfigured, or M is determined according to a third threshold value and the third threshold value is predefined or preconfigured.

In some implementations, the third indication information being used to determine the N synchronization signals selected by the terminal device includes: the third indication information being used to indicate indexes of the N synchronization signals selected by the terminal device, where N is predefined or preconfigured, or N is determined according to a fourth threshold value and the fourth threshold value is predefined or preconfigured.

In some implementations, the third indication information is carried in one or more of the following transmissions: a random access signal, an uplink transmission of random access response scheduling, or an uplink transmission after completion of a random access procedure.

In some implementations, a first antenna port set associated with the first synchronization signal is determined according to predefined or preconfigured information, or a second antenna port associated with the first synchronization signal is determined according to predefined or preconfigured information.

In embodiments of the present application, a wireless communication method is provided. The method includes the following. A network device sends a synchronization signal, where the synchronization signal includes a first synchronization signal, and the first synchronization signal is used to determine at least one antenna port associated with the first synchronization signal.

In some implementations, the at least one antenna port is an antenna port in a first antenna port set and the first synchronization signal is associated with the first antenna port set.

In some implementations, the first synchronization signal is sent according to a first association, and the first synchronization signal and the first association are used to determine the first antenna port set.

In some implementations, the first association includes at least one of: a correspondence between one synchronization signal and one antenna port set; a correspondence between one synchronization signal and antenna port sets; a correspondence between synchronization signals and one antenna port set; a one-to-one correspondence between synchronization signals and antenna port sets; a correspondence between one synchronization-signal index and one antenna-port-set identifier; a correspondence between one synchronization-signal index and antenna-port-set identifiers; a correspondence between synchronization-signal indexes and one antenna-port-set identifier; or a one-to-one correspondence between synchronization-signal indexes and antenna-port-set identifiers.

In some implementations, the first synchronization signal is used to determine an identifier of the first antenna port set or the first synchronization signal is used to determine an identifier of the at least one antenna port in the first antenna port set.

In some implementations, the identifier of the first antenna port set or the identifier of the at least one antenna port in the first antenna port set is determined according to one or more of the following information: an index of the first synchronization signal; a synchronization signal sequence corresponding to the first synchronization signal; or information transmitted over a downlink channel associated with the first synchronization signal.

In some implementations, where the first synchronization signal is sent through some antenna ports in the first antenna port set; or the first synchronization signal is sent through all antenna ports in the first antenna port set; or the first antenna port set includes a primary antenna port, and the first synchronization signal is sent through the primary antenna port.

In some implementations, a synchronization signal that is not associated with the first antenna port set is not sent through some antenna ports in the first antenna port set; or a synchronization signal that is not associated with the first antenna port set is not sent through all antenna ports in the first antenna port set; or the first antenna port set includes a primary antenna port, and a synchronization signal that is not associated with the first antenna port set is not sent through the primary antenna port; or the first antenna port set includes a secondary antenna port, and a synchronization signal that is not associated with the first antenna port set is not sent through the secondary antenna port.

In some implementations, the first antenna port set and a first random access occasion set have a second association, and/or the first synchronization signal and the first random access occasion set have the second association, and the method further includes: receiving, by the network device, a random access signal in at least one random access occasion in the first random access occasion set, where the at least one random access occasion is determined according to the second association.

In some implementations, the first synchronization signal includes a synchronization signal with a strongest received signal strength detected by a terminal device or a synchronization signal with a received signal strength exceeding a first threshold detected by the terminal device.

In some implementations, the second association is predefined or preconfigured.

In some implementations, receiving, by the network device, the random access signal in the at least one random access occasion in the first random access occasion set includes at least one of: receiving, by the network device, the random access signal through an antenna port for sending the first synchronization signal in the first antenna port set; or receiving, by the network device, the random access signal through some antenna ports in the first antenna port set; or receiving, by the network device, the random access signal through all antenna ports in the first antenna port set; or receiving, by the network device, the random access signal through a primary antenna port in the first antenna port set; or receiving, by the network device, the random access signal through a secondary antenna port in the first antenna port set.

In some implementations, the method further includes: sending, by the network device, a random access response through the at least one antenna port in the first antenna port set; or the first antenna port set includes a primary antenna port and sending, by the network device, a random access response through the primary antenna port, where the random access response is in response to the random access signal sent by a terminal device.

In some implementations, the at least one antenna port in the first antenna port set is used to transmit first indication information, and the first indication information is used to determine at least one of the following information: an identifier of the first antenna port set; identifiers of antenna ports included in the first antenna port set; an identifier of a primary antenna port in the first antenna port set; an identifier of a secondary antenna port in the first antenna port set; an identifier of an antenna port for sending the first synchronization signal in the first antenna port set; an identifier of an antenna port for detecting a random access signal in the first antenna port set; an identifier of an antenna port for sending a random access response in the first antenna port set; an index of a synchronization signal transmitted in a communication network in which the first antenna port set is located; an index of a synchronization signal associated with the first antenna port set; an index of a synchronization signal for which rate matching is performed during data transmission through an antenna port in the first antenna port set; a type of a quasi co-location relationship associated with the first antenna port set; or an association between the first antenna port set and a first random access occasion set.

In some implementations, the first indication information is transmitted through the antenna port for sending the first synchronization signal in the first antenna port set; or the first indication information is transmitted through the antenna port for detecting the random access signal in the first antenna port set; or the first indication information is transmitted through all antenna ports in the first antenna port set.

In some implementations, when the first antenna port set includes two or more antenna ports, at least two antenna ports in the first antenna port set are distributed antenna ports or any two antenna ports in the first antenna port set are distributed antenna ports.

In some implementations, the at least one antenna port includes a second antenna port, and the first synchronization signal is associated with the second antenna port.

In some implementations, the first synchronization signal is sent according to a third association, and the first synchronization signal and the third association are used to determine the second antenna port.

In some implementations, the third association includes at least one of a correspondence between one synchronization signal and one antenna port; a correspondence between one synchronization signal and antenna ports; a correspondence between synchronization signals and one antenna port; a one-to-one correspondence between synchronization signals and antenna ports; a correspondence between one synchronization-signal index and one antenna port identifier; a correspondence between one synchronization-signal index and antenna port identifiers; a correspondence between synchronization-signal indexes and one antenna port identifier; or a one-to-one correspondence between synchronization-signal indexes and antenna port identifiers.

In some implementations, the first synchronization signal is used to determine an identifier of the second antenna port.

In some implementations, the identifier of the second antenna port is determined according to one or more of the following information: an index of the first synchronization signal; a synchronization signal sequence corresponding to the first synchronization signal; or information transmitted over a downlink channel associated with the first synchronization signal.

In some implementations, the first synchronization signal is sent through the second antenna port; and/or a synchronization signal that is not associated with the second antenna port is not sent through the second antenna port.

In some implementations, the second antenna port and a second random access occasion set have a fourth association, and/or the first synchronization signal and the second random access occasion set have the fourth association, and the method further includes: receiving, by the network device, a random access signal; and/or sending, by the network device, a random access response sent through the second antenna port, where the random access signal is sent in at least one random access occasion in the second random access occasion set, the at least one random access occasion is determined according to the fourth association, and the random access response is in response to the random access signal sent by a terminal device.

In some implementations, the random access signal is sent through the second antenna port in the at least one random access occasion.

In some implementations, the first synchronization signal includes a synchronization signal with a strongest received signal strength detected by the terminal device or a synchronization signal with a received signal strength exceeding a second threshold detected by the terminal device.

In some implementations, the fourth association is predefined or preconfigured.

In some implementations, the second antenna port is used to transmit second indication information, and the second indication information is used to determine at least one of the following information: an identifier of the second antenna port; an index of a synchronization signal transmitted in a communication network in which the second antenna port is located; an index of a synchronization signal associated with the second antenna port; an index of a synchronization signal for which rate matching is performed during data transmission through the second antenna port; a type of a quasi co-location relationship associated with the second antenna port; or an association between the second antenna port and a second random access occasion set.

In some implementations, the method further includes: receiving, by the network device, third indication information sent by a terminal device, where the third indication information is used to determine M antenna ports selected by the terminal device and/or N synchronization signals selected by the terminal device, and N and M are positive integers.

In some implementations, the third indication information being used to determine the M antenna ports selected by the terminal device includes: the third indication information being used to indicate identifiers of the M antenna ports selected by the terminal device, where M is predefined or preconfigured, or M is determined according to a third threshold value and the third threshold value is predefined or preconfigured.

In some implementations, the third indication information being used to determine the N synchronization signals selected by the terminal device includes: the third indication information being used to indicate indexes of the N synchronization signals selected by the terminal device, where N is predefined or preconfigured, or N is determined according to a fourth threshold value and the fourth threshold value is predefined or preconfigured.

In some implementations, the third indication information is carried in one or more of the following transmissions: a random access signal, an uplink transmission of random access response scheduling, or an uplink transmission after completion of a random access procedure.

In some implementations, a first antenna port set associated with the first synchronization signal is determined according to predefined or preconfigured information, or a second antenna port associated with the first synchronization signal is determined according to predefined or preconfigured information.

In embodiments of the present application, a terminal device is provided. The terminal device includes a processor, a memory, and a communication interface. The memory is used to store one or more computer programs, and the processor is used to invoke the computer program in the memory to cause the terminal device to execute part or all of the steps in the method of the first aspect.

In embodiments of the present application, a network device is provided. The network device includes a processor, a memory, and a communication interface. The memory is used to store one or more computer programs, and the processor is used to invoke the computer program in the memory to cause the network device to execute part or all of the steps in the method of the second aspect.

In embodiments of the present application, embodiments of the present application provide a communication system. The communication system includes the above-mentioned terminal device and/or network device. In another possible design, the system may also include other devices that interact with the terminal device or the network device in the solution provided in the embodiments of the present application.

In embodiments of the present application, embodiments of the present application provide a chip. The chip includes a memory and a processor. The processor can invoke and run a computer program from the memory to implement part or all of the steps described in the methods of the above aspects.

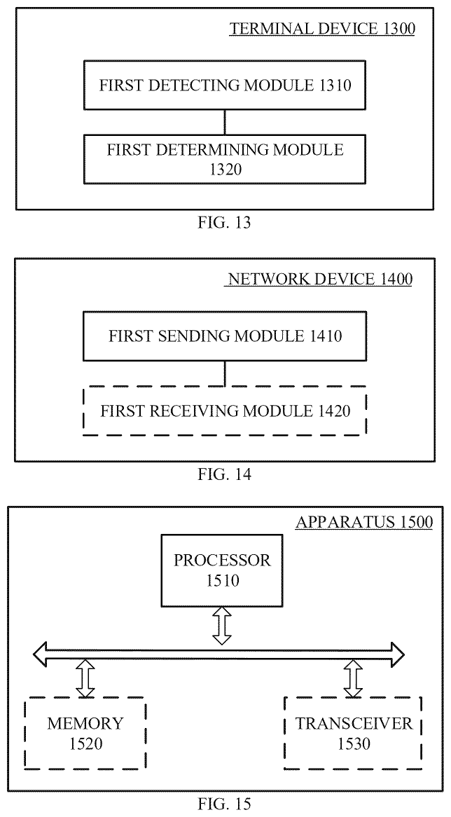

The method embodiment of the present application is described in detail above in conjunction with FIGS. 1 to 12. The device embodiment of the present application is described in detail below in conjunction with FIGS. 13 to 15. It should be understood that the description of the method embodiment corresponds to the description of the device embodiment. Therefore, for portions not described in detail, reference can be made to the above method embodiment.

FIG. 13 is a schematic structural diagram of a terminal device provided in embodiments of the present application. The terminal device 1300 illustrated in FIG. 13 may include a first detecting module 1310 and a first determining module 1320.

The first detecting module 1310 may be configured to detect a synchronization signal sent by a network device.

The first determining module 1320 may be configured to determine at least one antenna port associated with a first synchronization signal according to the first synchronization signal, after the terminal device detects the first synchronization signal.

Optionally, the at least one antenna port is an antenna port in a first antenna port set and the first synchronization signal is associated with the first antenna port set.

Optionally, the first synchronization signal is sent according to a first association, and the first determining module is further configured to: determine the first antenna port set according to the first synchronization signal and the first association.

Optionally, the first association includes at least one of: a correspondence between one synchronization signal and one antenna port set; a correspondence between one synchronization signal and antenna port sets; a correspondence between synchronization signals and one antenna port set; a one-to-one correspondence between synchronization signals and antenna port sets; a correspondence between one synchronization-signal index and one antenna-port-set identifier; a correspondence between one synchronization-signal index and antenna-port-set identifiers; a correspondence between synchronization-signal indexes and one antenna-port-set identifier; or a one-to-one correspondence between synchronization-signal indexes and antenna-port-set identifiers.

Optionally, the first determining module is further configured to: determine an identifier of the first antenna port set according to the first synchronization signal; or determine an identifier of the at least one antenna port in the first antenna port set according to the first synchronization signal.

Optionally, the identifier of the first antenna port set or the identifier of the at least one antenna port in the first antenna port set is determined according to one or more of the following information: an index of the first synchronization signal; a synchronization signal sequence corresponding to the first synchronization signal; or information transmitted over a downlink channel associated with the first synchronization signal.

Optionally, the first synchronization signal is sent through some antenna ports in the first antenna port set; or the first synchronization signal is sent through all antenna ports in the first antenna port set; or the first antenna port set includes a primary antenna port, and the first synchronization signal is sent through the primary antenna port.

Optionally, a synchronization signal that is not associated with the first antenna port set is not sent through some antenna ports in the first antenna port set; or a synchronization signal that is not associated with the first antenna port set is not sent through all antenna ports in the first antenna port set; or the first antenna port set includes a primary antenna port, and a synchronization signal that is not associated with the first antenna port set is not sent through the primary antenna port; or the first antenna port set includes a secondary antenna port, and a synchronization signal that is not associated with the first antenna port set is not sent through the secondary antenna port.

Optionally, the first antenna port set and a first random access occasion set have a second association, and/or the first synchronization signal and the first random access occasion set have the second association, and the terminal device further includes: a second determining module configured to determine at least one random access occasion in the first random access occasion set according to the second association; and a first sending module configured to send a random access signal in the at least one random access occasion.

Optionally, the first synchronization signal includes a synchronization signal with a strongest received signal strength detected by the terminal device or a synchronization signal with a received signal strength exceeding a first threshold detected by the terminal device.

Optionally, the second association is predefined or preconfigured.

Optionally, sending, by the terminal device, the random access signal in the at least one random access occasion includes at least one of: sending, by the terminal device, the random access signal through an antenna port for sending the first synchronization signal in the first antenna port set; or sending, by the terminal device, the random access signal through some antenna ports in the first antenna port set; or sending, by the terminal device, the random access signal through all antenna ports in the first antenna port set; or sending, by the terminal device, the random access signal through a primary antenna port in the first antenna port set; or sending, by the terminal device, the random access signal through a secondary antenna port in the first antenna port set.

Optionally, the terminal device further includes a second detecting module, where the second detecting module is configured to detect a random access response sent through the at least one antenna port in the first antenna port set; or the first antenna port set includes a primary antenna port and the second detecting module is configured to detect a random access response sent through the primary antenna port, where the random access response is in response to the random access signal sent by the terminal device.

Optionally, the at least one antenna port in the first antenna port set is used to transmit first indication information, and the first indication information is used to determine at least one of the following information: an identifier of the first antenna port set; identifiers of antenna ports included in the first antenna port set; an identifier of a primary antenna port in the first antenna port set; an identifier of a secondary antenna port in the first antenna port set; an identifier of an antenna port for sending the first synchronization signal in the first antenna port set; an identifier of an antenna port for detecting a random access signal in the first antenna port set; an identifier of an antenna port for sending a random access response in the first antenna port set; an index of a synchronization signal transmitted in a communication network in which the first antenna port set is located; an index of a synchronization signal associated with the first antenna port set; an index of a synchronization signal for which rate matching is performed during data transmission through an antenna port in the first antenna port set; a type of a quasi co-location relationship associated with the first antenna port set; or an association between the first antenna port set and a first random access occasion set.

Optionally, the first indication information is transmitted through the antenna port for sending the first synchronization signal in the first antenna port set; or the first indication information is transmitted through the antenna port for detecting the random access signal in the first antenna port set; or the first indication information is transmitted through all antenna ports in the first antenna port set.

Optionally, when the first antenna port set includes two or more antenna ports, at least two antenna ports in the first antenna port set are distributed antenna ports or any two antenna ports in the first antenna port set are distributed antenna ports.

Optionally, the at least one antenna port includes a second antenna port, and the first synchronization signal is associated with the second antenna port.

Optionally, the first synchronization signal is sent according to a third association, and the first determining module is further configured to: determine the second antenna port according to the first synchronization signal and the third association.

Optionally, the third association includes at least one of: a correspondence between one synchronization signal and one antenna port; a correspondence between one synchronization signal and antenna ports; a correspondence between synchronization signals and one antenna port; a one-to-one correspondence between synchronization signals and antenna ports; a correspondence between one synchronization-signal index and one antenna port identifier; a correspondence between one synchronization-signal index and antenna port identifiers; a correspondence between synchronization-signal indexes and one antenna port identifier; or a one-to-one correspondence between synchronization-signal indexes and antenna port identifiers.

Optionally, the first determining module is further configured to: determine an identifier of the second antenna port according to the first synchronization signal.

Optionally, the identifier of the second antenna port is determined according to one or more of the following information: an index of the first synchronization signal; a synchronization signal sequence corresponding to the first synchronization signal; or information transmitted over a downlink channel associated with the first synchronization signal.

Optionally, the first synchronization signal is sent through the second antenna port; and/or a synchronization signal that is not associated with the second antenna port is not sent through the second antenna port.

Optionally, the second antenna port and a second random access occasion set have a fourth association, and/or the first synchronization signal and the second random access occasion set have the fourth association, and the terminal device further includes: a third determining module configured to determine at least one random access occasion in the second random access occasion set according to the fourth association, and sending, by the terminal device, a random access signal in the at least one random access occasion; and/or a third detecting module configured to detect a random access response sent through the second antenna port, where the random access response is in response to the random access signal sent by the terminal device.

Optionally, sending, by the terminal device, the random access signal in the at least one random access occasion includes: sending, by the terminal device, the random access signal through the second antenna port in the at least one random access occasion.

Optionally, the first synchronization signal includes a synchronization signal with a strongest received signal strength detected by the terminal device or a synchronization signal with a received signal strength exceeding a second threshold detected by the terminal device.

Optionally, the fourth association is predefined or preconfigured.

Optionally, the second antenna port is used to transmit second indication information, and the second indication information is used to determine at least one of the following information: an identifier of the second antenna port; an index of a synchronization signal transmitted in a communication network in which the second antenna port is located; an index of a synchronization signal associated with the second antenna port; an index of a synchronization signal for which rate matching is performed during data transmission through the second antenna port; a type of a quasi co-location relationship associated with the second antenna port; or an association between the second antenna port and a second random access occasion set.

Optionally, the terminal device further includes a second sending module configured to: send third indication information to the network device, where the third indication information is used to determine M antenna ports selected by the terminal device and/or N synchronization signals selected by the terminal device, and N and M are positive integers.

Optionally, the third indication information being used to determine the M antenna ports selected by the terminal device includes: the third indication information being used to indicate identifiers of the M antenna ports selected by the terminal device, where M is predefined or preconfigured, or M is determined according to a third threshold value and the third threshold value is predefined or preconfigured.

Optionally, the third indication information being used to determine the N synchronization signals selected by the terminal device includes: the third indication information being used to indicate indexes of the N synchronization signals selected by the terminal device, where N is predefined or preconfigured, or N is determined according to a fourth threshold value and the fourth threshold value is predefined or preconfigured.

Optionally, the third indication information is carried in one or more of the following transmissions: a random access signal, an uplink transmission of random access response scheduling, or an uplink transmission after completion of a random access procedure.

Optionally, a first antenna port set associated with the first synchronization signal is determined according to predefined or preconfigured information, or a second antenna port associated with the first synchronization signal is determined according to predefined or preconfigured information.

FIG. 14 is a schematic structural diagram of a network device provided in embodiments of the present application. The network device 1400 illustrated in FIG. 14 may include a first sending module 1410.

The first sending module 1410 may be configured to send a synchronization signal, where the synchronization signal includes a first synchronization signal, and the first synchronization signal is used to determine at least one antenna port associated with the first synchronization signal.

Optionally, the at least one antenna port is an antenna port in a first antenna port set and the first synchronization signal is associated with the first antenna port set.

Optionally, the first synchronization signal is sent according to a first association, and the first synchronization signal and the first association are used to determine the first antenna port set.

Optionally, the first association includes at least one of: a correspondence between one synchronization signal and one antenna port set; a correspondence between one synchronization signal and antenna port sets; a correspondence between synchronization signals and one antenna port set; a one-to-one correspondence between synchronization signals and antenna port sets; a correspondence between one synchronization-signal index and one antenna-port-set identifier; a correspondence between one synchronization-signal index and antenna-port-set identifiers; a correspondence between synchronization-signal indexes and one antenna-port-set identifier; or a one-to-one correspondence between synchronization-signal indexes and antenna-port-set identifiers.

Optionally, the first synchronization signal is used to determine an identifier of the first antenna port set or the first synchronization signal is used to determine an identifier of the at least one antenna port in the first antenna port set.

Optionally, the identifier of the first antenna port set or the identifier of the at least one antenna port in the first antenna port set is determined according to one or more of the following information: an index of the first synchronization signal; a synchronization signal sequence corresponding to the first synchronization signal; or information transmitted over a downlink channel associated with the first synchronization signal.

Optionally, the first synchronization signal is sent through some antenna ports in the first antenna port set; or the first synchronization signal is sent through all antenna ports in the first antenna port set; or the first antenna port set includes a primary antenna port, and the first synchronization signal is sent through the primary antenna port.

Optionally, a synchronization signal that is not associated with the first antenna port set is not sent through some antenna ports in the first antenna port set; or a synchronization signal that is not associated with the first antenna port set is not sent through all antenna ports in the first antenna port set; or the first antenna port set includes a primary antenna port, and a synchronization signal that is not associated with the first antenna port set is not sent through the primary antenna port; or the first antenna port set includes a secondary antenna port, and a synchronization signal that is not associated with the first antenna port set is not sent through the secondary antenna port.

Optionally, the first antenna port set and a first random access occasion set have a second association, and/or the first synchronization signal and the first random access occasion set have the second association, and the network device further includes: a first receiving module 1420 configured to receive a random access signal in at least one random access occasion in the first random access occasion set, where the at least one random access occasion is determined according to the second association.

Optionally, the first synchronization signal includes a synchronization signal with a strongest received signal strength detected by a terminal device or a synchronization signal with a received signal strength exceeding a first threshold detected by the terminal device.

Optionally, the second association is predefined or preconfigured.

Optionally, receiving, by the network device, the random access signal in the at least one random access occasion in the first random access occasion set includes at least one of: receiving, by the network device, the random access signal through an antenna port for sending the first synchronization signal in the first antenna port set; or receiving, by the network device, the random access signal through some antenna ports in the first antenna port set; or receiving, by the network device, the random access signal through all antenna ports in the first antenna port set; or receiving, by the network device, the random access signal through a primary antenna port in the first antenna port set; or receiving, by the network device, the random access signal through a secondary antenna port in the first antenna port set.

Optionally, the network device further includes a second sending module, where the second sending module is configured to send a random access response through the at least one antenna port in the first antenna port set; or the first antenna port set includes a primary antenna port and the second sending module is configured to send a random access response through the primary antenna port, where the random access response is in response to the random access signal sent by a terminal device.

Optionally, the at least one antenna port in the first antenna port set is used to transmit first indication information, and the first indication information is used to determine at least one of the following information: an identifier of the first antenna port set; identifiers of antenna ports included in the first antenna port set; an identifier of a primary antenna port in the first antenna port set; an identifier of a secondary antenna port in the first antenna port set; an identifier of an antenna port for sending the first synchronization signal in the first antenna port set; an identifier of an antenna port for detecting a random access signal in the first antenna port set; an identifier of an antenna port for sending a random access response in the first antenna port set; an index of a synchronization signal transmitted in a communication network in which the first antenna port set is located; an index of a synchronization signal associated with the first antenna port set; an index of a synchronization signal for which rate matching is performed during data transmission through an antenna port in the first antenna port set; a type of a quasi co-location relationship associated with the first antenna port set; or an association between the first antenna port set and a first random access occasion set.

Optionally, the first indication information is transmitted through the antenna port for sending the first synchronization signal in the first antenna port set; or the first indication information is transmitted through the antenna port for detecting the random access signal in the first antenna port set; or the first indication information is transmitted through all antenna ports in the first antenna port set.

Optionally, when the first antenna port set includes two or more antenna ports, at least two antenna ports in the first antenna port set are distributed antenna ports or any two antenna ports in the first antenna port set are distributed antenna ports.

Optionally, the at least one antenna port includes a second antenna port, and the first synchronization signal is associated with the second antenna port.

Optionally, the first synchronization signal is sent according to a third association, and the first synchronization signal and the third association are used to determine the second antenna port.

Optionally, the third association includes at least one of: a correspondence between one synchronization signal and one antenna port; a correspondence between one synchronization signal and antenna ports; a correspondence between synchronization signals and one antenna port; a one-to-one correspondence between synchronization signals and antenna ports; a correspondence between one synchronization-signal index and one antenna port identifier; a correspondence between one synchronization-signal index and antenna port identifiers; a correspondence between synchronization-signal indexes and one antenna port identifier; or a one-to-one correspondence between synchronization-signal indexes and antenna port identifiers.

Optionally, the first synchronization signal is used to determine an identifier of the second antenna port.

Optionally, the identifier of the second antenna port is determined according to one or more of the following information: an index of the first synchronization signal; a synchronization signal sequence corresponding to the first synchronization signal; or information transmitted over a downlink channel associated with the first synchronization signal.

Optionally, the first synchronization signal is sent through the second antenna port; and/or a synchronization signal that is not associated with the second antenna port is not sent through the second antenna port.

Optionally, the second antenna port and a second random access occasion set have a fourth association, and/or the first synchronization signal and the second random access occasion set have the fourth association, and the network device further includes: a second receiving module configured to receive a random access signal; and/or a third sending module configured to send a random access response sent through the second antenna port, where the random access signal is sent in at least one random access occasion in the second random access occasion set, the at least one random access occasion is determined according to the fourth association, and the random access response is in response to the random access signal sent by a terminal device.

Optionally, the random access signal is sent through the second antenna port in the at least one random access occasion.

Optionally, the first synchronization signal includes a synchronization signal with a strongest received signal strength detected by the terminal device or a synchronization signal with a received signal strength exceeding a second threshold detected by the terminal device.

Optionally, the fourth association is predefined or preconfigured.

Optionally, the second antenna port is used to transmit second indication information, and the second indication information is used to determine at least one of the following information: an identifier of the second antenna port; an index of a synchronization signal transmitted in a communication network in which the second antenna port is located; an index of a synchronization signal associated with the second antenna port; an index of a synchronization signal for which rate matching is performed during data transmission through the second antenna port; a type of a quasi co-location relationship associated with the second antenna port; or an association between the second antenna port and a second random access occasion set.

Optionally, the network device further includes: a third receiving module configured to receive third indication information sent by a terminal device, where the third indication information is used to determine M antenna ports selected by the terminal device and/or N synchronization signals selected by the terminal device, and N and M are positive integers.

Optionally, the third indication information being used to determine the M antenna ports selected by the terminal device includes: the third indication information being used to indicate identifiers of the M antenna ports selected by the terminal device, where M is predefined or preconfigured, or M is determined according to a third threshold value and the third threshold value is predefined or preconfigured.

Optionally, the third indication information being used to determine the N synchronization signals selected by the terminal device includes: the third indication information being used to indicate indexes of the N synchronization signals selected by the terminal device, where N is predefined or preconfigured, or N is determined according to a fourth threshold value and the fourth threshold value is predefined or preconfigured.

Optionally, the third indication information is carried in one or more of the following transmissions: a random access signal, an uplink transmission of random access response scheduling, or an uplink transmission after completion of a random access procedure.

Optionally, a first antenna port set associated with the first synchronization signal is determined according to predefined or preconfigured information, or a second antenna port associated with the first synchronization signal is determined according to predefined or preconfigured information.

FIG. 15 is a schematic structural diagram of a communication apparatus according to embodiments of the present application. The dashed lines in FIG. 15 indicate that a unit or module is optional. The apparatus 1500 may be used to implement the method described in the above method embodiment. The apparatus 1500 may be a chip, a terminal device, or a network device.

The apparatus 1500 may include one or more processors 1510. The processor 1510 may support the apparatus 1500 to implement the methods described in the above method embodiments. The processor 1510 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field programmable gate array (FPGA), or other programmable logic device, discrete gate or transistor logic device, discrete hardware component, etc. The general-purpose processor may be a microprocessor, or the processor may be any conventional processor, etc.

The apparatus 1500 may further include one or more memories 1520. The memory 1520 store programs that, when executed by the processor 1510, cause the processor 1510 to perform the methods described in the above method embodiments. The memory 1520 may be independent of the processor 1510 or integrated into the processor 1510.

The apparatus 1500 may further include a transceiver 1530. The processor 1510 may communicate with other devices or chips via the transceiver 1530. For example, the processor 1510 may transmit and receive data with other devices or chips via the transceiver 1530.

The present application also provides a computer-readable storage medium. The computer-readable storage medium is for storing a program. The computer-readable storage medium can be applied to a terminal or network device provided in the present application, and the program causes a computer to execute the method performed by the terminal or network device in embodiments of the present application.

The present application also provides a computer program product. The computer program product includes a program. The computer program product can be applied to a terminal or network device provided in the present application, and the program causes a computer to execute the method performed by the terminal or network device in embodiments of the present application.

The embodiments of the present application also provide a computer program. The computer program can be applied to the terminal or network device provided in the embodiments of the present application, and the computer program causes a computer to execute the method performed by the terminal or network device in embodiments of the present application.

It should be understood that the terms “system” and “network” in the present application can be used interchangeably. In addition, the terms used in the present application are only used to explain the specific embodiments of the present application and are not intended to limit the present application. The terms “first”, “second”, “third”, and “fourth” in the specification and claims of the present application and the accompanying drawings are used to distinguish different objects rather than to describe a specific order. In addition, the terms “including” and “having” and any variations thereof are intended to cover non-exclusive inclusions.

In the embodiments of the present application, the term “indication” may refer to a direct indication, an indirect indication, or an indication of an association. Exemplarily, A indicating B can have the following meanings. A directly indicates B, for example, B can be obtained through A. Alternatively, A indirectly indicates B, for example, A indicates C and B can be obtained through C. Alternatively, there is an association between A and B.

In the embodiment of the present application, “B corresponding to A” means that B is associated with A and B can be determined according to A. However, it should be understood that determining B according to A does not mean determining B based merely on A, but B can also be determined according to A and/or other information.

In the embodiments of the present application, the term “corresponding” may indicate a direct or indirect correspondence between the two, or an association between the two, or can mean relationships such as indication and being indicated or configuration and being configured, etc.

In the embodiments of the present application, the term “include” can refer to direct inclusion or indirect inclusion. Alternatively, the term “include” in the embodiments of the present application can be replaced with “indicates” or “is used to determine.” For example, “A includes B” can be replaced with “A indicates B” or “A is used to determine B.”

In the embodiments of the present application, “pre-define” or “pre-configure” may be implemented by pre-storing corresponding codes, tables, or other methods that can be used to indicate relevant information in a device (e.g., a terminal device or a network device). The present application does not limit the specific implementation. For example, pre-definition may refer to a definition in a protocol.

In the embodiments of the present application, the “protocol” may refer to a standard protocol in the communication field, for example, it may include an LTE protocol, an NR protocol, and related protocols used in future communication systems, and the present application does not limit this.

In the embodiments of the present application, the term “and/or” is simply a description of the association between related objects, indicating that three relationships can exist. For example, A and/or B can represent: A alone, both A and B, and B alone. In addition, the character “/” in this article generally indicates that the objects associated with each other are in an “or” relationship.

In various embodiments of the present application, the magnitude of the serial numbers of the above-mentioned processes does not mean the order of execution. The order of execution of each process should be determined by its function and internal logic, and should not constitute any limitation on the implementation process of the embodiments of the present application.

In the several embodiments provided in the present application, it should be understood that the disclosed systems, devices, and methods can be implemented in other ways. For example, the device embodiments described above are merely schematic. For example, the division of the units is merely a logical function division. In actual implementation, there may be other division methods, such as multiple units or components can be combined or integrated into another system, or some features can be ignored or not executed. Another point is that the mutual coupling or direct coupling or communication connection illustrated or discussed can be through some interfaces, indirect coupling or communication connection of devices or units, which can be electrical, mechanical or other forms.

The units described as separate components may or may not be physically separate, and the components illustrated as units may or may not be physical units, that is, they may be located in one place or distributed across multiple network units. Some or all of the units may be selected to achieve the purpose of the embodiment according to actual needs.

In addition, each functional unit in each embodiment of the present application may be integrated into one processing unit, or each unit may exist physically separately, or two or more units may be integrated into one unit.

In the above embodiments, all or part of the embodiments can be implemented using software, hardware, firmware, or any combination thereof. When implemented using software, all or part of the embodiments can be implemented in the form of a computer program product. The computer program product includes one or more computer instructions. When the computer program instructions are loaded and executed on a computer, all or part of the processes or functions described in the embodiments of the present application are generated. The computer can be a general-purpose computer, a special-purpose computer, a computer network, or other programmable device. The computer instructions can be stored in a computer-readable storage medium or transmitted from one computer-readable storage medium to another. For example, the computer instructions can be transmitted from one website, computer, server, or data center to another website, computer, server, or data center via wired (e.g., coaxial cable, optical fiber, digital subscriber line (DSL)) or wireless (e.g., infrared, wireless, microwave, etc.) means. The computer-readable storage medium can be any computer-readable medium or a data storage device such as a server or data center that integrates one or more computer-readable media. The available medium may be a magnetic medium (e.g., a floppy disk, a hard disk, a magnetic tape), an optical medium (e.g., a digital versatile disc (DVD)), or a semiconductor medium (e.g., a solid state drive (SSD)).

The above description is merely an implementation of the present application, but the scope of protection of the present application is not limited thereto. Any changes or substitutions that can be easily conceived by a person skilled in the art within the technical scope disclosed in the present application should be included in the scope of protection of the present application. Therefore, the scope of protection of the present application should be based on the scope of protection of the claims.

What is claimed is:

1. A wireless communication method, comprising:
detecting, by a terminal device, a synchronization signal sent by a network device; and
determining, by the terminal device, at least one antenna port associated with a first synchronization signal according to the first synchronization signal, after the terminal device detects the first synchronization signal.

2. The method of claim 1, wherein the at least one antenna port is an antenna port in a first antenna port set and the first synchronization signal is associated with the first antenna port set.

3. The method of claim 2, wherein the first synchronization signal is sent according to a first association, and determining, by the terminal device, the at least one antenna port associated with the first synchronization signal according to the first synchronization signal comprises:
determining, by the terminal device, the first antenna port set according to the first synchronization signal and the first association, wherein the first association comprises at least one of a correspondence between one synchronization signal and one antenna port set;
a correspondence between one synchronization signal and antenna port sets;
a correspondence between synchronization signals and one antenna port set;
a one-to-one correspondence between synchronization signals and antenna port sets;
a correspondence between one synchronization-signal index and one antenna-port-set identifier;
a correspondence between one synchronization-signal index and antenna-port-set identifiers;
a correspondence between synchronization-signal indexes and one antenna-port-set identifier; or
a one-to-one correspondence between synchronization-signal indexes and antenna-port-set identifiers.

4. The method of claim 2, wherein determining, by the terminal device, the at least one antenna port associated with the first synchronization signal according to the first synchronization signal comprises:
determining, by the terminal device, an identifier of the first antenna port set according to the first synchronization signal; or
determining, by the terminal device, an identifier of the at least one antenna port in the first antenna port set according to the first synchronization signal, wherein
the identifier of the first antenna port set or the identifier of the at least one antenna port in the first antenna port set is determined according to one or more of the following information:
an index of the first synchronization signal;
a synchronization signal sequence corresponding to the first synchronization signal; or
information transmitted over a downlink channel associated with the first synchronization signal.

5. The method of claim 2, wherein
the first synchronization signal is sent through some antenna ports in the first antenna port set; or
the first synchronization signal is sent through all antenna ports in the first antenna port set; or
the first antenna port set comprises a primary antenna port, and the first synchronization signal is sent through the primary antenna port.

6. The method of claim 2, wherein
a synchronization signal that is not associated with the first antenna port set is not sent through some antenna ports in the first antenna port set; or
a synchronization signal that is not associated with the first antenna port set is not sent through all antenna ports in the first antenna port set; or
the first antenna port set comprises a primary antenna port, and a synchronization signal that is not associated with the first antenna port set is not sent through the primary antenna port; or
the first antenna port set comprises a secondary antenna port, and a synchronization signal that is not associated with the first antenna port set is not sent through the secondary antenna port.

7. The method of claim 2, wherein the first antenna port set and a first random access occasion set have a second association, and/or the first synchronization signal and the first random access occasion set have the second association, and the method further comprises:
determining, by the terminal device, at least one random access occasion in the first random access occasion set according to the second association; and
sending, by the terminal device, a random access signal in the at least one random access occasion, wherein
the first synchronization signal comprises a synchronization signal with a strongest received signal strength detected by the terminal device or a synchronization signal with a received signal strength exceeding a first threshold detected by the terminal device.

8. The method of claim 7, wherein sending, by the terminal device, the random access signal in the at least one random access occasion comprises at least one of:
sending, by the terminal device, the random access signal through an antenna port for sending the first synchronization signal in the first antenna port set; or
sending, by the terminal device, the random access signal through some antenna ports in the first antenna port set; or
sending, by the terminal device, the random access signal through all antenna ports in the first antenna port set; or
sending, by the terminal device, the random access signal through a primary antenna port in the first antenna port set; or
sending, by the terminal device, the random access signal through a secondary antenna port in the first antenna port set.

9. The method of claim 2, wherein the at least one antenna port in the first antenna port set is used to transmit first indication information, and the first indication information is used to determine at least one of the following information:
an identifier of the first antenna port set;
identifiers of antenna ports comprised in the first antenna port set;
an identifier of a primary antenna port in the first antenna port set;
an identifier of a secondary antenna port in the first antenna port set;
an identifier of an antenna port for sending the first synchronization signal in the first antenna port set;
an identifier of an antenna port for detecting a random access signal in the first antenna port set;
an identifier of an antenna port for sending a random access response in the first antenna port set;
an index of a synchronization signal transmitted in a communication network in which the first antenna port set is located;
an index of a synchronization signal associated with the first antenna port set;
an index of a synchronization signal for which rate matching is performed during data transmission through an antenna port in the first antenna port set;
a type of a quasi co-location relationship associated with the first antenna port set; or
an association between the first antenna port set and a first random access occasion set, wherein
the first indication information is transmitted through the antenna port for sending the first synchronization signal in the first antenna port set; or
the first indication information is transmitted through the antenna port for detecting the random access signal in the first antenna port set; or
the first indication information is transmitted through all antenna ports in the first antenna port set.

10. The method of claim 2, wherein when the first antenna port set comprises two or more antenna ports, at least two antenna ports in the first antenna port set are distributed antenna ports or any two antenna ports in the first antenna port set are distributed antenna ports.

11. A wireless communication method, comprising:
sending, by a network device, a synchronization signal, wherein
the synchronization signal comprises a first synchronization signal, and the first synchronization signal is used to determine at least one antenna port associated with the first synchronization signal.

12. The method of claim 11, wherein the at least one antenna port comprises a second antenna port, and the first synchronization signal is associated with the second antenna port.

13. The method of claim 12, wherein the first synchronization signal is sent according to a third association, and the first synchronization signal and the third association are used to determine the second antenna port, wherein the third association comprises at least one of:
a correspondence between one synchronization signal and one antenna port;
a correspondence between one synchronization signal and antenna ports;
a correspondence between synchronization signals and one antenna port;
a one-to-one correspondence between synchronization signals and antenna ports;
a correspondence between one synchronization-signal index and one antenna port identifier;
a correspondence between one synchronization-signal index and antenna port identifiers;
a correspondence between synchronization-signal indexes and one antenna port identifier; or
a one-to-one correspondence between synchronization-signal indexes and antenna port identifiers.

14. The method of claim 12, wherein the first synchronization signal is used to determine an identifier of the second antenna port, and the identifier of the second antenna port is determined according to one or more of the following information:
an index of the first synchronization signal;
a synchronization signal sequence corresponding to the first synchronization signal; or
information transmitted over a downlink channel associated with the first synchronization signal.

15. The method of claim 12, wherein
the first synchronization signal is sent through the second antenna port; and/or
a synchronization signal that is not associated with the second antenna port is not sent through the second antenna port.

16. The method of claim 12, wherein the second antenna port and a second random access occasion set have a fourth association, and/or the first synchronization signal and the second random access occasion set have the fourth association, and the method further comprises:
receiving, by the network device, a random access signal; and/or
sending, by the network device, a random access response sent through the second antenna port, wherein
the random access signal is sent in at least one random access occasion in the second random access occasion set, the at least one random access occasion is determined according to the fourth association, and the random access response is in response to the random access signal sent by a terminal device;
the random access signal is sent through the second antenna port in the at least one random access occasion; and
the first synchronization signal comprises a synchronization signal with a strongest received signal strength detected by the terminal device or a synchronization signal with a received signal strength exceeding a second threshold detected by the terminal device.

17. The method of claim 12, wherein the second antenna port is used to transmit second indication information, and the second indication information is used to determine at least one of the following information:
an identifier of the second antenna port;
an index of a synchronization signal transmitted in a communication network in which the second antenna port is located;
an index of a synchronization signal associated with the second antenna port;
an index of a synchronization signal for which rate matching is performed during data transmission through the second antenna port;
a type of a quasi co-location relationship associated with the second antenna port; or
an association between the second antenna port and a second random access occasion set.

18. The method of claim 12, further comprising:
receiving, by the network device, third indication information sent by a terminal device, wherein the third indication information is used to determine M antenna ports selected by the terminal device and/or N synchronization signals selected by the terminal device, and N and M are positive integers, wherein
the third indication information being used to determine the M antenna ports selected by the terminal device comprises:
the third indication information being used to indicate identifiers of the M antenna ports selected by the terminal device, wherein M is predefined or preconfigured, or M is determined according to a third threshold value and the third threshold value is predefined or preconfigured; and
the third indication information being used to determine the N synchronization signals selected by the terminal device comprises:
the third indication information being used to indicate indexes of the N synchronization signals selected by the terminal device, wherein N is predefined or preconfigured, or N is determined according to a fourth threshold value and the fourth threshold value is predefined or preconfigured.

19. The method of claim 18, wherein the third indication information is carried in one or more of the following transmissions: a random access signal, an uplink transmission of random access response scheduling, or an uplink transmission after completion of a random access procedure.

20. A terminal device, comprising:
a transceiver;
at least one processor; and
a memory coupled to the at least one processor and storing at least one computer program which, when executed by the at least one processor, causes the at least one processor to:
detect a synchronization signal sent by a network device; and
determine at least one antenna port associated with a first synchronization signal according to the first synchronization signal, after the terminal device detects the first synchronization signal.
